(19) United States
(12) Patent Application Publication
(10) Pub. No.: US 2023/0005082 A1
(43) Pub. Date: Jan. 5, 2023

(54) EXPERIENTIAL ACTIVITES FOR THE VIRTUAL PLATFORM

(71) Applicants: Lisa Sulmasy, North Grafton, MA (US); Cassandra Smith, Whitehouse Station, NJ (US); MacKenzie Grenier, Warwick, RI (US); Timothy Cieslak, Wayne, NJ (US); Gabriela Interian, Wethersfield, CT (US); Christine Koulopoulos, Pepperell, MA (US); Brian Wu, Hopewell Junction, NY (US); Parker Shawver, Bethany Beach, DE (US)

(72) Inventors: Lisa Sulmasy, North Grafton, MA (US); Cassandra Smith, Whitehouse Station, NJ (US); MacKenzie Grenier, Warwick, RI (US); Timothy Cieslak, Wayne, NJ (US); Gabriela Interian, Wethersfield, CT (US); Christine Koulopoulos, Pepperell, MA (US); Brian Wu, Hopewell Junction, NY (US); Parker Shawver, Bethany Beach, DE (US)

(73) Assignee: Rensselaer Polytechnic Institute, Troy, NY (US)

(21) Appl. No.: 17/854,623

(22) Filed: Jun. 30, 2022

Related U.S. Application Data
(60) Provisional application No. 63/217,245, filed on Jun. 30, 2021.

(51) Int. Cl. G06Q 50/00; G06Q 10/06; G06F 3/0487; G06F 3/16

(52) U.S. Cl. CPC G06Q 50/01; G06Q 10/06; G06F 3/0487; G06F 3/167

(57) ABSTRACT

One embodiment provides a computing device for remote experiential teambuilding activities. The computing device includes a communication circuitry and a user interface (UI). The communication circuitry is configured to couple to a remote computing device via a network. The remote computing device is associated with a remote participant. The UI is configured to receive a local user input from a local participant, and to provide at least one of a local device output or a remote device output to the local participant. The local user input, local device output and remote device output are related to a selected experiential activity.

### CROSS REFERENCE TO RELATED APPLICATION(S)

This application claims the benefit of U.S. Provisional Application No. 63/217,245, filed Jun. 30, 2021, which is incorporated by reference as if disclosed herein in its entirety.

### FIELD

The present disclosure is related to experiential activities, in particular to, experiential activities for the virtual platform.

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The experiential education community is built on bringing teams together and challenging them to learn from their experiences. This may be achieved through a combination of facilitation of team building activities and discussion on their application to the real world. When operating remotely, many organizations (including professional experiential educators) may struggle to transfer this ideology to a virtual platform.

Team building activities configured for in-person learning may not easily transfer to a remote environment, while some team building activities (e.g., ropes course) may not transfer at all. Experiential learning generally includes learning by doing followed by reflection on the experience. Participants in remote activities may be relatively more susceptible to local distractions that may not be present in an in-person learning environment. Thus, implementing experiential teambuilding activities remotely presents challenges.

### SUMMARY

In some embodiments, there is provided a computing device for remote experiential teambuilding activities. The computing device includes a communication circuitry and a user interface (UI). The communication circuitry is configured to couple to a remote computing device via a network. The remote computing device is associated with a remote participant. The UI is configured to receive a local user input from a local participant, and to provide at least one of a local device output or a remote device output to the local participant. The local user input, local device output and remote device output are related to a selected experiential activity.

In some embodiments of the computing device, the selected experiential activity is selected from the group including Team Tapestry, Human Mirror, Me-Moji, Ship Shape, Fact or Fiction, Robot Assembly, Virtual Card Pick-Up, Link to Link, Survey Says, Take a Stand, Straw Stacker, Stranded in Quarantine and Codebreaker.

In some embodiments, the computing device further includes storage configured to store a plurality of modules. Each module corresponds to a selected off-the-shelf application or program.

In some embodiments of the computing device, the UI includes one or more of a camera, a microphone, and/or a loudspeaker, and is configured to facilitate engagement of the local participant in the experiential activity in a virtual environment.

In some embodiments of the computing device, each module is selected from the group including a web browser, a search engine, a virtual platform configured to facilitate remote video communication, a game-based learning platform, an online encyclopedia, a chat application, a messaging application, a drawing application, a live polling platform, a website that provides digital images “emojis” used to express emotion, an application with forms, and/or a presentation application.

In some embodiments of the computing device, the selected experiential activity includes a plurality of levels of difficulty.

In some embodiments of the computing device, each experiential activity has an associated goal. The associated goal is selected from the group including self-reflection, getting to know people, trust building, team building, communication, conflict resolution, ice breaking, group bonding, problem solving, teamwork, group dynamics, common goal, get participants outside of their comfort zones, consensus building, energizer, and goal setting.

In some embodiments, there is provided a method for remote experiential teambuilding activities. The method includes coupling, by a communication circuitry, to a remote computing device via a network. The remote computing device is associated with a remote participant. The method further includes receiving, by a user interface (UI), a local user input from a local participant; and providing, by the UI, at least one of a local device output or a remote device output to the local participant. The local user input, local device output and remote device output are related to a selected experiential activity.

In some embodiments of the method, the selected experiential activity is selected from the group including Team Tapestry, Human Mirror, Me-Moji, Ship Shape, Fact or Fiction, Robot Assembly, Virtual Card Pick-Up, Link to Link, Survey Says, Take a Stand, Straw Stacker, Stranded in Quarantine and Codebreaker.

In some embodiments, the method further includes storing, by storage, a plurality of modules. Each module corresponds to a selected off-the-shelf application or program.

In some embodiments of the method, the UI includes one or more of a camera, a microphone, and/or a loudspeaker, and is configured to facilitate engagement of the local participant in the experiential activity in a virtual environment.

In some embodiments of the method, each module is selected from the group including a web browser, a search engine, a virtual platform configured to facilitate remote video communication, a game-based learning platform, an online encyclopedia, a chat application, a messaging application, a drawing application, a live polling platform, a website that provides digital images “emojis” used to express emotion, an application with forms, and/or a presentation application.

In some embodiments of the method, the selected experiential activity includes a plurality of levels of difficulty.

In some embodiments of the method, each experiential activity has an associated goal, the associated goal selected from the group including self-reflection, getting to know people, trust building, team building, communication, conflict resolution, ice breaking, group bonding, problem solving, teamwork, group dynamics, common goal, get participants outside of their comfort zones, consensus building, energizer, and goal setting.

In an embodiment, there is provided a system for remote experiential teambuilding activities. The system includes a local computing device; at least one remote computing device; and a network. Each remote computing device is associated with a respective remote participant. The local computing device includes a communication circuitry, and a user interface (UI). The communication circuitry is configured to couple to the at least one remote computing device via the network. The UI is configured to receive a local user input from a local participant, and to provide at least one of a local device output or a remote device output to the local participant. The local user input, local device output and remote device output are related to a selected experiential activity.

In some embodiments of the system, the selected experiential activity is selected from the group including Team Tapestry, Human Mirror, Me-Moji, Ship Shape, Fact or Fiction, Robot Assembly, Virtual Card Pick-Up, Link to Link, Survey Says, Take a Stand, Straw Stacker, Stranded in Quarantine and Codebreaker.

In some embodiments of the system, the local computing device further includes storage configured to store a plurality of modules, each module corresponding to a selected off-the-shelf application or program.

In some embodiments of the system, the UI includes one or more of a camera, a microphone, and/or a loudspeaker, and is configured to facilitate engagement of the local participant in the experiential activity in a virtual environment.

In some embodiments of the system, each module is selected from the group including a web browser, a search engine, a virtual platform configured to facilitate remote video communication, a game-based learning platform, an online encyclopedia, a chat application, a messaging application, a drawing application, a live polling platform, a website that provides digital images “emojis” used to express emotion, an application with forms, and/or a presentation application.

In some embodiments of the system, the selected experiential activity includes a plurality of levels of difficulty.

In some embodiments, there is provided a computer readable storage device. The device has stored thereon instructions that when executed by one or more processors result in the following operations including any embodiment of the method.

### BRIEF DESCRIPTION OF THE DRAWINGS

The drawings show embodiments of the disclosed subject matter for the purpose of illustrating features and advantages of the disclosed subject matter. However, it should be understood that the present application is not limited to the precise arrangements and instrumentalities shown in the drawings, wherein:

FIG. 1 illustrates a functional block diagram of an experiential activities system consistent with several embodiments of the present disclosure;

FIGS. 2A through 2D illustrate example poses associated with a Human Mirror activity, according to an embodiment of the present disclosure;

FIGS. 3A through 3C illustrate example ship illustrations associated with a Ship Shape activity, according to an embodiment of the present disclosure;

FIGS. 4A and 4B illustrate an example assembled robot and robot components, respectively, associated with a Robot Assembly activity, according to an embodiment of the present disclosure;

FIG. 5 illustrates an array of cards, each card containing a unique activity, associated with a Virtual Card Pick Up activity, according to an embodiment of the present disclosure;

FIGS. 6A and 6B illustrate relatively easy example puzzles associated with a Straw Stacker activity, according to an embodiment of the present disclosure;

FIGS. 7A and 7B illustrate example puzzles of medium complexity associated with the Straw Stacker activity, according to an embodiment of the present disclosure;

FIGS. 8A through 8C illustrate relatively difficult example puzzles associated with a Straw Stacker activity, according to an embodiment of the present disclosure; and

FIG. 9 is a flowchart of example experiential activities operations consistent with several embodiments of the present disclosure.

### DETAILED DESCRIPTION

Generally, this disclosure relates to experiential activities for a virtual platform, i.e., experiential activities that are performed by participants who are physically remote from each other. The experiential activities are thus performed using computing devices linked by a network. The computing devices are configured to use (i.e., execute) modules that provide a virtual platform for the remote experiential activities. A collection of virtual experiential activities, as will be described in more detail below, include, but are not limited to ice-breaking, team-building, communication, motivation, conflict management, etc.

The remote experiential activities, as described herein, are configured to utilize the computing devices to couple a local participant and one or more remote participants. The remote experiential activities are configured to be engaging for the participants, in the remote environment. For example, participants may be engaged by using their senses, including creative visualization to enlist focus and attention, and/or gamification techniques to facilitate participant engagement. In an embodiment, the modules may include off-the-shelf applications and/or programs, thus, providing a relatively low cost of deployment. Thus, experiential teambuilding activities may be performed remotely, using an apparatus, system and/or method, as described herein.

An apparatus, method and/or system include a computing device for remote experiential teambuilding activities between a plurality of users (i.e., participants) who are positioned (i.e., located) remotely from one another. The computing device may include a memory circuitry, a communication circuitry, a user interface (UI), and a processor circuitry. The communication circuitry is configured to couple to at least one remote computing device via a network. The UI is configured to receive a local user input from a local user (i.e., local participant). The processor circuitry is configured to process the received local user input to yield a local device output. The communication circuitry is further configured to transmit the local device output to at least one remote computing device via the network, and to receive a respective remote device output from each of the at least one remote computing device via the network. The processor is further configured to process each received remote device output. The UI is further configured to provide each processed received remote device output to the local user (i.e., local participant). The local user input and remote device output are associated with a selected experiential activity.

In an embodiment, there is provided a computing device for remote experiential teambuilding activities. The computing device includes a communication circuitry and a user interface (UI). The communication circuitry is configured to couple to a remote computing device via a network. The remote computing device is associated with a remote participant. The UI is configured to receive a local user input from a local participant, and to provide at least one of a local device output or a remote device output to the local participant. The local user input, local device output and remote device output are related to a selected experiential activity.

Thus, a computing device and associated modules provides a virtual platform configured to facilitate participation of remotely located participants in experiential activities, according to the present disclosure.

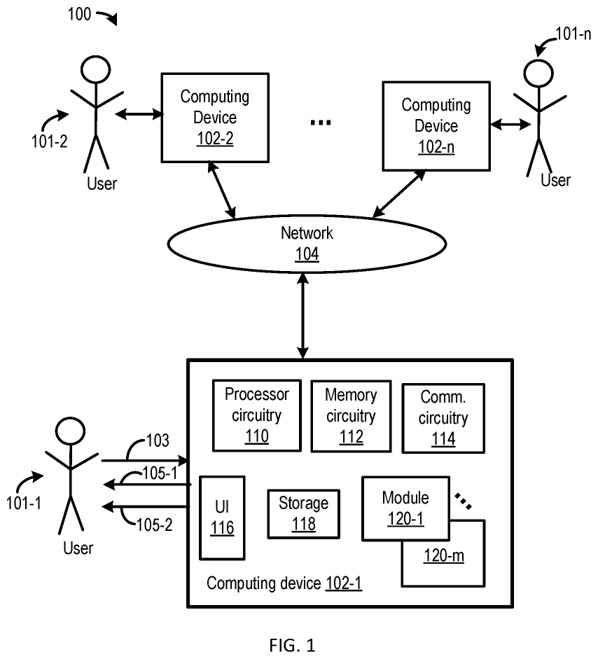

FIG. 1 illustrates a functional block diagram of an experiential activities system 100 consistent with several embodiments of the present disclosure. Experiential activities system 100 includes a plurality of computing devices 102-1, 102-2, . . . , 102-n and a network 104. Each computing device, e.g., computing device 102-1, may be positioned remote from at least one other computing device, e.g., computing device(s) 102-2, . . . , and/or 102-n. Each computing device is configured to couple to each other computing device via the network 104. Each computing device, e.g., computing device 102-1, may be associated with a local respective user, e.g., user 101-1. A user may be a participant in an experiential activity or may be a facilitator of the experiential activity. Generally, there may be a plurality of participants and at least one facilitator.

Each computing device 102-1, 102-2, . . . , 102-n is configured to receive information from and to provide information to the local respective user. Thus, a first computing device 102-1 is configured to provide information to and receive information from a first user 101-1, a second computing device 102-2 is configured to provide information to and receive information from a second user 101-2, and an n^{th} computing device 102-n is configured to provide information to and receive information from an n^{th} user 101-n. The information may include a local user input 103, local device output 105-1 and/or one or more remote device output(s) 105-2, as described herein.

Computing devices 102-1, 102-2, . . . , 102-n may include, but are not limited to, a mobile telephone including, but not limited to a smart phone (e.g., iPhone®, Android®-based phone, Blackberry®, Symbian®-based phone, Palm®-based phone, etc.); a computing system (e.g., a server, a workstation computer, a desktop computer, a laptop computer, a tablet computer (e.g., iPad®, GalaxyTab® and the like), an ultraportable computer, an ultramobile computer, a netbook computer and/or a subnotebook computer; etc. Network 104 is configured to couple a plurality of computing devices, e.g., computing devices 102-1, 102-2, . . . , and/or 102-n, wired and/or wirelessly.

Each computing device, e.g., computing device 102-1, includes a processor circuitry 110, a memory circuitry 112, a communication circuitry 114 and a user interface 116. Computing device 102-1 may further include storage 118. In some embodiments, computing device 102-1 may include one or more modules 120-1, . . . , 120-m.

Processor circuitry 110 may include, but is not limited to, a single core processing unit, a multicore processor, a graphics processing unit, a microcontroller, an application-specific integrated circuit (ASIC), a field programmable gate array (FPGA), a programmable logic device (PLD), etc. Memory circuitry 112 may be configured to store information and/or data associated with operation of computing device 102-1. Communication circuitry 114 is configured to couple computing device 102-1 to network 104 and thus to one or more remote computing device(s), e.g., computing device(s) 102-2, . . . , and/or 102-n. User interface 116 may include a user input device (e.g., keyboard, keypad, mouse, touchpad, microphone, camera, pointing device, touch sensitive display, etc.) and/or a user output device (e.g., a display, loudspeaker). User interface 116 may thus be configured to receive local user input 103 from user 101-1, and to provide local device output 105-1 and/or remote device output 105-2 to user 101-1, as will be described in more detail below.

Memory circuitry 112 and/or storage 118 may be configured to store one or more modules 120-1, . . . , and/or 120-m. Modules 120-1, . . . , 120-m correspond to applications and/or programs, and may be stored in memory 112 and/or storage 118. Modules 120-1, . . . , 120-m may include, but are not limited to, a web browser (e.g., Google Chrome, Microsoft Edge, Apple Safari, Mozilla Firefox, etc.), a search engine (e.g., Google, Bing, etc.), a virtual platform (e.g., Zoom, Webex, etc.) configured to facilitate remote video communication, a game-based learning platform (e.g., Kahoot!, Filament games, etc.), an online encyclopedia (e.g., Wikipedia, etc.), a chat application, a messaging application (e.g., Teams, Slack, etc.), a drawing application (e.g., Google Drawings, etc.), a live polling platform (e.g., Menti, https://www.mentimeter.com/app), a website that provides digital images “emojis” used to express emotion (e.g., https://get-emoji.com/), an application with forms (e.g., Google Form, Excel Sheet with Form Results, Kahoot with Facts), a presentation application (e.g., PowerPoint), etc. Modules 120-1, . . . , 120-m may thus include “off-the-shelf” applications and/or programs, configured to process local user input, e.g., local user input 103, and to provide local device output, e.g., local device output 105-1 and/or remote device output 105-2.

Thus, experiential activities system 100 may be configured to couple a local participant and one or more remote participants. The participants may then participate in remote experiential activities utilizing experiential activities system 100. The remote experiential activities are configured to be engaging for the participants, in the remote environment. The modules may include off-the-shelf applications and/or programs, thus, providing a relatively low cost of deployment. Thus, experiential teambuilding activities may be performed remotely, using an apparatus, system and/or method, as described herein.

In an embodiment, there is provided a computing device for remote experiential teambuilding activities. The computing device includes a communication circuitry and a user interface (UI). The communication circuitry is configured to couple to a remote computing device via a network. The remote computing device is associated with a remote participant. The UI is configured to receive a local user input from a local participant, and to provide at least one of a local device output or a remote device output to the local participant. The local user input, local device output and remote device output are related to a selected experiential activity.

Selected experiential activities include Team Tapestry, Human Mirror, Me-Moji, Ship Shape, Fact or Fiction, Robot Assembly, Virtual Card Pick-Up, Link to Link, Survey Says, Take a Stand, Straw Stacker, Stranded in Quarantine and/or Codebreaker. Each experiential activity may include a plurality of participants and at least one facilitator. The facilitator may “manage” each experiential activity and each participant may participate in a particular experiential activity.

Each experiential activity is described in more detail below. In the following description, each experiential activity is described using an Experiential Activity descriptive format. The Experiential Activity descriptive format corresponds to instructions for the experiential activities. The Experiential Activity descriptive format includes a heading portion arranged in sections that include Goals, Breakout Room Size, Time, Virtual Platform, Facilitator Materials, and Participant Materials. The Experiential Activity descriptive format further includes a body portion arranged in sections that include Set Up, Directions, Virtual Tips/Notes, and Platform Pros/Cons, and may include Note and/or Variations. The Experiential Activity descriptive format is configured to facilitate implementation of the experiential activities by the facilitator(s) and the participants, as described herein.

The heading portion is configured to provide guidance information associated with each experiential activity. The Goals section is configured to provide a short description of the goals of each experiential activity. Breakout Room Size corresponds to a number of participants in a subgroup associated with each experiential activity. Each subgroup may be isolated from each other subgroup, when there are a plurality of subgroups by, for example, the virtual platform. Time corresponds to a target time duration, in minutes, for an associated experiential activity. Virtual Platform is configured to provide a suggestion for a module (e.g., Zoom, Google Draw) that may be used for the associated experiential activity. Facilitator Materials corresponds to materials and/or resources (e.g., Wikipedia) that a facilitator may use for the associated experiential activity. Participant Materials corresponds to materials and/or resources (e.g., screen-sharing capabilities, writing utensils, etc.) that a participant may use for the associated experiential activity.

The body portion is configured to provide activity details including instructions, variations, “things to know”, etc. Set Up relates to preparatory tasks. Directions corresponds to instructions for each experiential activity and may include instructions for the facilitator(s) and/or participants. Virtual Tips/Notes are configured to provide additional and/or alternative details regarding an associated experiential activity. Platform Pros/Cons relate to operation of each module. Note, if present, may provide guidance (e.g., whether or not to perform a selected experiential activity) regarding the experiential activity. Variations, if present, are configured to provide descriptions of variations on a selected experiential activity.

Thus, the Experiential Activity descriptive format is configured to facilitate implementation of each experiential activity on a computing device, e.g., computing device 102-1, of FIG. 1, using one or more module(s) 120-1, . . . , and/or 120-m.

### Experiential Activity: Team Tapestry

In the Team Tapestry experiential activity, a participant may reflect upon their day, workshop experience, or organization and choose a color that best represents how they are feeling. After searching for this color using, for example, a search engine, and saving an image of that color to their computing device, each participant may change their virtual background to that color. Once each participant has chosen a virtual background color, a “tapestry” of colors has been created, and each participant may share the reasoning behind their color choice. The facilitator may take a picture of the created tapestry to share with the participants.

For each participant and each participant's respective computing device 102-1, 102-2, . . . , 102-n, each participant's color selection corresponds to a respective local user input 103, e.g., capturing a mouse click configured to select the desired color from a plurality of color options. A local device output 105-1 may then correspond to a video image of a local participant with the selected color(s) as background. A remote device output 105-2 may then correspond to a video image of a remote participant, e.g., user 101-2 with the remote participant's selected color(s) as background. A facilitator computing device, e.g., computing device 102-n, may then be configured to receive a plurality of remote device outputs that correspond to each participant's video image and respective color background. The facilitator's computing device may then be configured to capture and image of the combined remote device outputs to yield a facilitator local device output.

Table 1A includes a description of the Team Tapestry experiential activity, in the Experiential Activity descriptive format, as described herein.

TABLE 1A
Experiential Activity: Team Tapestry

Goals: Self-Reflection, Getting to Know People, Communication of Feelings/Trust, Conclusion
Breakout Room Size: 4-14
Time: 8-25 minutes
Virtual Platform: Zoom/WebEx
Facilitator Materials: None
Participant Materials: None
Set Up:
No Set Up required
Directions:
Each participant should take a moment to think about how they are feeling
When they are ready, each participant should search for a color using, for example, Google,
that describes how they are feeling
Could be how they're feeling at that moment, how they are feeling about school,
how they are feeling about their organization, how they are feeling about their role
within an organization, etc.
Have each participant save a color to their desktop and use it as their virtual background
Then, have each participant share popcorn style why they chose that color-i.e. how they
are feeling
Optional: have everyone smile and take a screenshot at the end to save their virtual tapestry
Virtual Tips/Notes:
This is a slow/low energy activity. It's great for conclusion processing but you should think
about what type of day the group has had/is going to have and whether or not this is the
best place to end
Some participants will choose the color because it is their favorite color. This is the
drawback of not having colors to choose in front of you like we do in person. Consider
prompting participants to go deeper or at least ask about how they are feeling if they say “I
don't know why I chose it, it's just a good color.”
Platform Pros/Cons:
You can change virtual background on both Zoom and WebEx, so there isn't a preference for
this activity.
Visual directions for Zoom are included in Table IB, below.
Table 1B includes instructions for Zoom for the Team Tapestry experiential activity, as
described herein. It may be appreciated that the Team Tapestry experiential activity may utilize a
different virtual platform, within the scope of the present disclosure.

TABLE 1B
Team Tapestry

| | |
|---|---|
| 1. | Search up a color that represents your current mood. |
| 2. | Right click on the picture and select “Save As” |
| 3 | Save the image in an easy to find location, like your desktop. |
| 4. | Click the up arrow next to the “Stop Video” button. |
| 5. | Select “Choose Virtual Background” |
| 6. | Click the plus sign, then “add image” to add a new background image. |
| 7. | Select the image you saved in Step 3. |
| 8. | Enjoy your new background. |

### Experiential Activity: Human Mirror

In the Human Mirror experiential activity, one participant is asked to be blindfolded, while the rest of the “seeing” participants may be able to direct them to complete a task by assuming a specific pose (from the chest up for safety). Each “seeing” participant may then say one repeatable word. The team may then use their words together to communicate with the blindfolded participant in an attempt to complete the pose given by the facilitator.

For example, a facilitator computing device may capture a verbal request (i.e., local user input 103) from the facilitator via a microphone (i.e., UI 116), the verbal request may be transformed to a digital representation (i.e., local device output 105-1) via processor circuitry 110, and transmitted via communication circuitry 114 over the network 104 to one or more remote computing devices 102-2, . . . , 102-n where it is received as remote device output at each participant computing device.

The blindfolded participant computing device may then capture an image (i.e., local user input) of the blindfolded participant using a camera (i.e., UI), the image may then be transformed to a digital representation (i.e., local device output) via processor circuitry, and transmitted via communication circuitry over the network to one or more remote computing devices where it is received as remote device output at each participant computing device. Respective processor circuitry at each participant computing device may then be configured to process the remote device output and a respective UI (e.g., display) may then provide the processed remote device output (e.g., image of the blindfolded participant) to the respective participant.

A selected “seeing” participant computing device may capture a spoken word (i.e., local user input) from the selected “seeing” participant via a microphone (i.e., UI), the spoken word may be transformed to a digital representation (i.e., local device output) via processor circuitry, and transmitted via communication circuitry over the network to one or more remote computing devices where it is received as remote device output at each participant (i.e., blindfolded participant and/or other “seeing” participant) computing device.

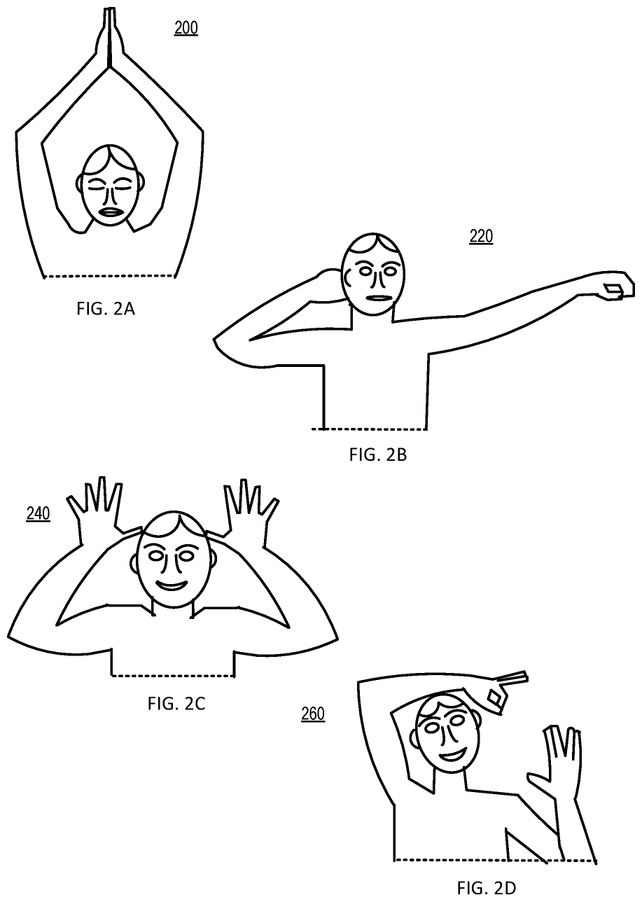

FIGS. 2A through 2D illustrate example poses associated with a Human Mirror activity, according to an embodiment of the present disclosure. FIG. 2A illustrates a first example pose 200, and includes arms over head, eyes closed and hands oriented with palms together. FIG. 2B illustrates a second example pose 220, and includes a left arm extended straight out from body and a right arm, bent so that a right hand is positioned behind and touching a head. FIG. 2C illustrates a third example pose 240, and includes both arms bent so that a respective thumb on each hand is touching a head above a respective ear, and fingers on each hand are extended and spread out. FIG. 2D illustrates a fourth example pose 260, and includes a left arm extended out from body, a left elbow bent so that a left forearm is vertical, and a left hand is positioned so that a middle finger and a ring finger are splayed. A right arm is bent so that a right is positioned above and touching a head, and a tip of a thumb and a tip of an index finger of a right hand are touching to form a circle, and remaining fingers are extending generally straight. A user's head may be further tipped toward the right arm.

It may be appreciated that the four poses 200, 220, 240, 260 illustrated in FIGS. 2A through 2D, are nonlimiting examples, and other poses may be implemented, within the scope of the present disclosure.

Table 2 includes a description of the Human Mirror experiential activity, in the Experiential Activity descriptive format, as described herein.

TABLE 2
Experiential Activity: Human Mirror

Goals: Trust Building, Team Building, Communication, Conflict Resolution
Breakout Room Size: 6-12
Time: 7-12 minutes per round, 30 minutes total
Virtual Platform: WebEx/Zoom
Facilitator Materials: Answer Key (see directions)
Participant Materials: Blindfold
Note:
Before beginning, gauge the comfort levels of the group with being blindfolded, on camera
given instructions, and moving one's body
If the group is not comfortable, consider doing a different activity altogether
Emphasize challenge by choice
Set Up:
No Set Up required
Directions:
The goal of this activity is to get a blindfolded participant to assume a position shown to the
seeing participants
The seeing participants may say one unique word to guide the volunteer
Participants can say their word multiple times, but choose and say a single word
Ask the group for a volunteer to be blindfolded (or at least to close their eyes)
While the volunteer gathers a blindfold, give the participants 2-3 minutes to determine
what each participant's word will be, and have them announce their words before
beginning the activity
The volunteer may not give input on what the words should be (at least for
round one)
Once the volunteer is blindfolded and the words have been assigned, the facilitator may
assume the goal pose to show the rest of the group
The group may then direct the blindfolded individual to move around until they reach the
given pose
Facilitator Note:
The blindfolded person may talk/ask questions, and the seeing participants may
respond with their chosen words.
For an added challenge, do not mention this ability to the participants unless
someone asks
Variations:
Show the participants the final pose every so often at the discretion of the facilitator
Show the participants the final pose for 20 seconds. They may then sacrifice a word in order
to see it again
Allow up to three opportunities to see the pose, shown when the team asks for it
Virtual Tips/Notes:
The virtual environment is an uncomfortable platform to be vulnerable. This activity may
generally be used with a relatively high functioning and trusting group.
Suggest using the gallery view to facilitate everyone seeing each other better
If you'd like to make your own pose, we recommend you keep it related to the chest and
higher, so that participants can still sit in their chair the entire time
This eliminates potential safety hazards and protects emotional safety
Platform Pros/Cons:
Both platforms work equally well with the gallery view of all participants

### Experiential Activity: Me-Moji

In the Me-Moji experiential activity, each participant may queue five emojis in their chat (messaging or video call chat, depending on the group) that describe themselves. One at a time, participants may send their emojis in the chat and describe the reasoning behind the chosen emojis before passing to the next person.

For example, each participant may select an emoji (i.e., local user input) via a mouse click (i.e., UI) with a corresponding cursor on an emoji, the selection may be transformed to a digital representation (i.e., local device output) via processor circuitry, and transmitted via communication circuitry over the network to one or more remote computing devices where it is received as remote device output at each participant computing device.

A selected participant computing device may capture a spoken explanation of the emoji selection (i.e., local user input) from the selected participant via a microphone (i.e., UI), the spoken explanation may be transformed to a digital representation (i.e., local device output) via processor circuitry, and transmitted via communication circuitry over the network to one or more remote computing devices where it is received as remote device output at each other participant computing device. The remote device output may then be processed by the respective processor and the processed remote device output may then be provided to each other participant via a loudspeaker (i.e., UI).

Table 3 includes a description of the Me-Emoji experiential activity, in the Experiential Activity descriptive format, as described herein.

TABLE 3
Experiential Activity: Me-Moji

Goals: Get to Know Each Other, Ice Breaker
Breakout Room Size: Any
Time: Allot 1 minute/person, then add 5-10
minutes Virtual Platform: WebEx/Zoom
Facilitator Materials: None
Participant Materials: Messaging tool with group (Teams, Slack, etc.). If not available, may use
https://get-emoji.com/ in the meeting chat
Set Up:
No Set Up required
Directions:
Give everyone 5 minutes to think of 5 emojis that describe themselves
Can be related to hobbies, family, school, aspirations, favorite things, etc.
One at a time, have participants send their 5 emojis in the chat, and explain why they
chose each of the 5
Virtual Tips/Notes:
Having people “popcorn” by calling on the next person once they are finished helps speed the
activity up and removes awkward transition time
This worked well in experiment because we got to know people while also learning about
the Slack channel!
Platform Pros/Cons:
If the group does not have their own messaging program, WebEx teams may be better for
this activity as they have a built-in chat and emojis
Otherwise, copying emojis off the internet and sending via Zoom chat also works,
although the Zoom chat doesn't show them in color
If color and exact emojis are desired, the facilitator can copy and paste the emojis
into a document, and share their screen. This is less advantageous in terms of seeing
all the participants in gallery view

### Experiential Activity: Ship Shape

In the Ship Shape experiential activity, each participant may choose their own shape and color to use to create a ship with their team. This experiential activity utilizes a drawing application to be able to collaborate in live time, i.e., configured to allow real time collaboration.

For example, from the perspective of a local participant computing device 102-1, a local user input 103 includes selection of a shape and color by the local participant (using, for example, a mouse click or a touch on a touch sensitive display) and a corresponding local device output 105-1 may be a digital representation of the selected shape and color. Continuing with the local computing device, a remote device output may then be a digital representation of a shape and color selected by a remote participant.

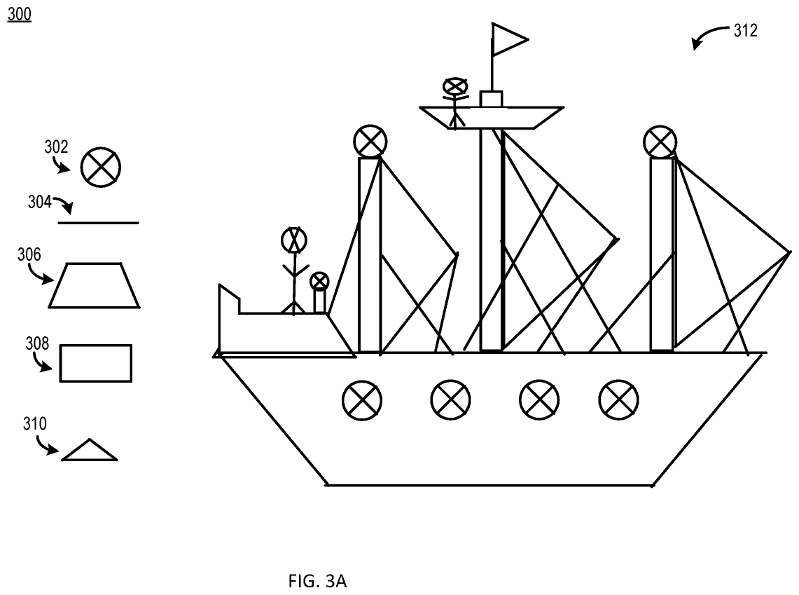

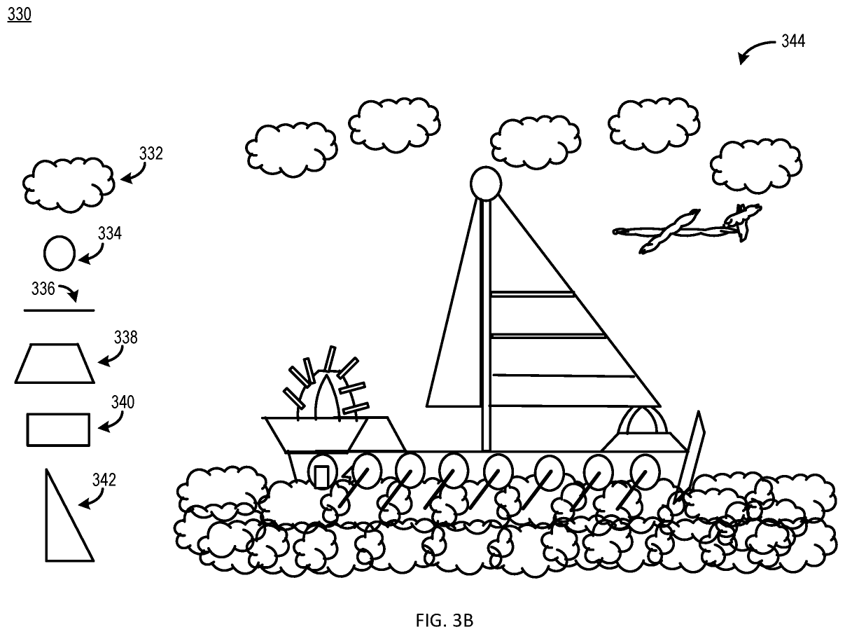

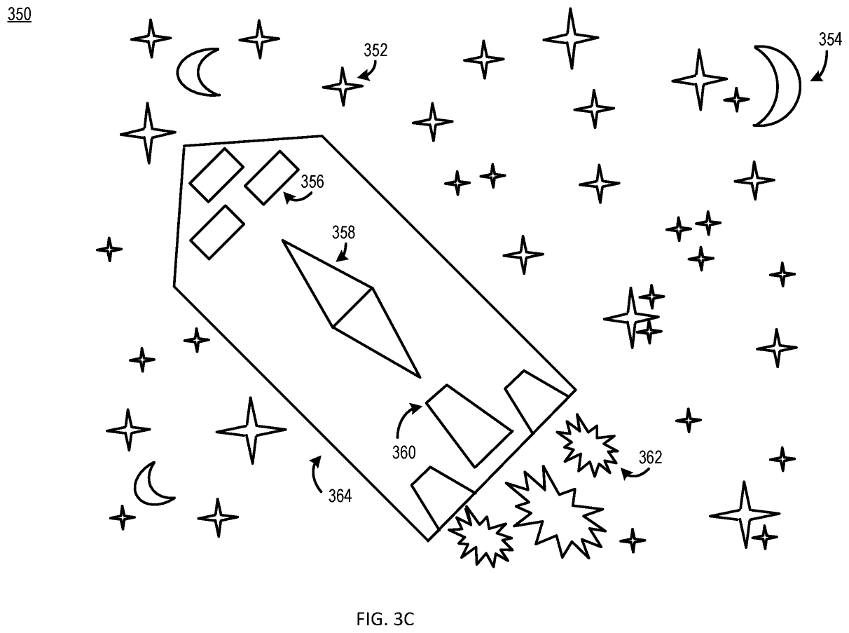

FIGS. 3A through 3C illustrate example ship illustrations associated with a Ship Shape experiential activity, according to an embodiment of the present disclosure. FIG. 3A illustrates a first example ship illustration 300, and includes a number of shapes: a circle with cross 302, a line 304, a trapezoid 306, a rectangle 308, and a triangle 310. The first ship illustration 300 further includes a finished ship 312, assembled from the provided shapes. FIG. 3B illustrates a second example ship illustration 330, and includes a number of shapes: a cloud 332, an ellipse 334, a line 336, a trapezoid 338, a rectangle 340, and a right triangle 342. The second ship illustration 330 further includes a finished ship 344, assembled from the provided shapes. FIG. 3C illustrates a third example ship illustration 350, and includes a number of shapes: a number of four point stars, e.g., star 352, a portion of a moon 354, a rectangle 356, a triangle 358, a trapezoid 360, and a blob with zigzag boundary 362. The third ship illustration 350 further includes a finished ship 364, assembled from the provided shapes. It may be appreciated that an orientation, size and/or aspect ratio of each shape may be adjusted. Additionally or alternatively, each shape may have an associated color, and/or fill pattern, according to the present disclosure. During the experiential activity, each participant may select their associated shape, color and/or fill pattern, as described herein.

It may be appreciated that the three ship illustrations 300, 330, 350 illustrated in FIGS. 3A through 3C, are nonlimiting examples, and other ships using similar and/or different shapes, may be implemented, within the scope of the present disclosure.

Table 4 includes a description of the Ship Shape experiential activity, in the Experiential Activity descriptive format, as described herein. The ship illustrations 300, 330, 350 illustrated in FIGS. 3A through 3C correspond to Examples of Ships, in Table 4.

TABLE 4
Experiential Activity: Ship Shape

Goals: To promote group bonding, problem solving, and teamwork while focusing on group
dynamics and roles. Competition styled activity.
Breakout Room Size: 4-6, at least 2 groups for competition
Time: 30 minutes
Virtual Platform: Zoom/WebEx, Google Drawings
Facilitator Materials: Google Drawings shared link, shared document to upload/view all created
ships Participant Materials: Access to Google Drawings
Set Up:
Each team may be given their own whiteboard on Google Drawings to draw on as a team in
their breakout room
Facilitator may also be on the document to monitor and “see what they are seeing”
Everyone may have edit access to the same document
Directions:
The group's goal is to create a best ship using the Shapes/Colors on Google Drawings
It will be judged on creativity, accuracy, and diversity of shapes/colors OR use the
poll feature in Webex/Zoom for participants to vote on their favorite ship
Everyone will select their own shape/color to complete the drawing
Everyone should contribute to the final ship drawing
The drawing should include a legend/key of each participant's name and their respective
shape/color
Give the group 5-7 minutes to plan their shapes and colors
Give the group 7 minutes to complete their team drawing
Time them on this. This will help to keep the competition fair
Once the group's drawing is complete, upload the final creation to the facilitation shared link
for full viewing or save a screenshot to present during judging
When presenting:
Facilitator or participants can share screen
Participants may describe their ship/scene
Virtual Tips/Notes:
Pre-plan and make the drawing links, shared ship uploading links
Confirm participants will have access to using Google Drawings during the facilitation
NOTE: facilitators may determine specific rules on shape and color selection
Depending on group size, may have each participant pick their own shape and own
individual color, or may allow multiple members to use the same shape but a
different color
Maintain the rules consistent amongst the teams and facilitators
Suggestion: may want to phrase selecting shapes/colors as a team effort, as opposed to
‘everyone will select their own shape and color’ and then make a ship, but rather have
them determine their tools as a team
Suggestion: Process/Debrief before leaving the breakout room to compare with other
teams. This will solidify the learning part before you go back to having fun
Platform Pros/Cons:
Can be hard for some participants to ‘get what they want’
Great energizer, team bonding, engaging activity
Examples of Ships-for facilitator eyes ONLY:

### Experiential Activity: Fact or Fiction

In the Fact or Fiction experiential activity, participants submit a true, but improbable fact about themselves. In the activity, each participant is privately sent someone else's fact and may then determine who it belongs to. Everyone is given approximately 3 guesses before the fact owner speaks up and shares a brief story about their fact.

For example, from the perspective of a local participant computing device 102-1, a local user input 103 includes entry of the fact by the local participant (using, for example, a keyboard, keypad or a touch sensitive display as the UI 116) and a corresponding local device output 105-1 may be a digital representation of the characters corresponding to the fact. Continuing with the local computing device 102-1, a remote device output 105-2 may then be a digital representation of characters corresponding to a fact provided by a remote participant. The digital representation of characters corresponding to the fact provided by the remote participant may be processed and the alphanumeric description may be provided to the participant visually using a display or provided as audio via a loudspeaker.

Table 5 includes a description of the Fact or Fiction experiential activity, in the Experiential Activity descriptive format, as described herein.

TABLE 5
Experiential Activity: Fact or Fiction

```
Goals: Icebreaker, Get to know each other
Breakout Room Size: 5-20
Time: 35 minutes
Virtual Platform: Zoom/WebEx, Kahoot
Facilitator Materials: Google Form, Excel Sheet with Form Results (Optional: Kahoot with Facts)
Participant Materials: (Optional: www.kahoot.com via phone or new tab)
Set Up:
  Pre-Facilitation: ask participants to fill out the Fact Google Form
  Optional: facilitator makes a Kahoot with 1 question per participant
    The question has 4 facts, 3 false and 1 true
    If a Kahoot is the final goal, provide entries in the Google Form for participants to
    write 3 false facts about themselves
Directions:
Version 1: Classic/Low-Tech
  Facilitator privately messages a fact to each participant at random
    It is suggested that they keep track of which fact is sent to each person
  One at a time, a participant will read aloud their fact and try to guess whose fact it is
  After two failed attempts, the correct person will reveal themselves and share an
  explanation about their fact as necessary
  That participant will then read their fact and repeat the process until everyone has shared
  If there is more than one “loop”, (i.e. if it comes back to the person who started but not
  everyone has shared yet) choose a second person to start back up again
Version 2: Kahoot Twist
  Facilitator shares Kahoot screen
  All participants may join the Kahoot via specific code on screen
  Each question relates to each participant, with 4 options, 3 of which are ‘fiction’ and 1 of
  which is a ‘fact’ about that person
  For each question, guess which statement you think is the fact about that person
  Once everyone votes, the correct ‘fact’ will be revealed
  The person whose fact it was can share a quick backstory or explanation of the fun fact
Virtual Tips/Notes:
  Facilitator: prepare the Kahoot in advance
  If there is a problem with Kahoot or screen sharing:
    The facilitator can read off the list of statements
    After each statement, participants can give a thumbs up or down (physically or with
    the platform's reaction feature) if they think the statement is true or false
Platform Pros/Cons:
  Kahoot: Very funky music, interactive, fun platform that most participants and facilitators
  are familiar with. Setup and work formatting each person's facts and fictions may be
  performed, in advance, but allows for a more interactive activity
```

### Experiential Activity: Robot Assembly

In the Robot Assembly experiential activity, participants are assigned 1 of 3 roles: builder, talker, or writer. The builders are in charge of assembling a robot, given all of its pieces. The talkers and writers are able to see the final robot assembly completed, and use either verbal or typed words to guide the builders (who cannot see the completed assembly).

For example, for talker participants and their respective computing devices, local user inputs 103 correspond to their speech and for writer participants and their respective computing devices, local user inputs 103 correspond to typed words/instructions. For builder participants and their respective computing devices, remote device outputs 105-2 are related to the speech and typed words/instructions of the talkers and writers, respectively.

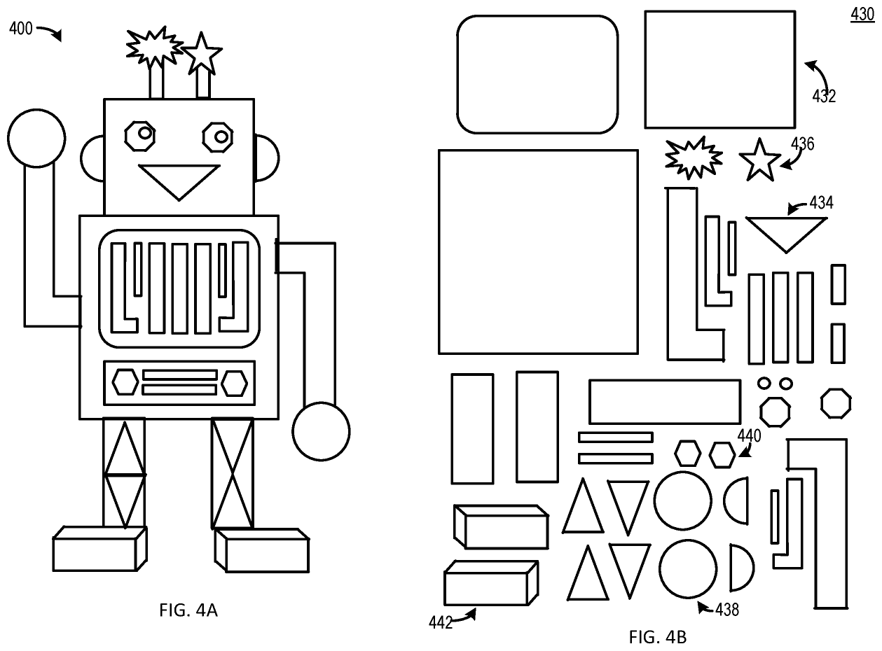

FIGS. 4A and 4B illustrate an example assembled robot 400 and example 430 robot components, respectively, associated with a Robot Assembly activity, according to an embodiment of the present disclosure. FIGS. 4A and 4B may be best understood when considered together. The example assembled robot 400 includes the components illustrated in example 430. The example 430 components include a plurality of rectangles, e.g., rectangle 432, a plurality of triangles, e.g., triangle 434, at least one star, e.g., star 436, a plurality of circles, e.g., circle 438, a plurality of multi-sided geometries, e.g., hexagon 440, and a plurality of three-dimensional blocks, e.g., block 442. It may be appreciated that the shapes can be assembled into the robot 400.

Table 6 includes a description of the Robot Assembly experiential activity, in the Experiential Activity descriptive format, as described herein.

TABLE 6
Experiential Activity: Robot Assembly

```
Goals: Communication, Group Dynamics, Teambuilding
Breakout Room Size: 4-8
Time: 35 minutes
Virtual Platform: Zoom/WebEx
Facilitator Materials: Picture of completed robot, 1 disassembled robot Google Drawing link per
  group
Participant Materials: Google Drawings capability
Set Up:
  Make one copy of the Robot Assembly drawing for each breakout room in the facilitation
  Ensure each copy has all the parts needed to emulate the master robot design
Directions:
  Have the group join a breakout room with their facilitator
    1 facilitator must stay in the main room, the “viewing room”, where participants from
    each team will visit one at a time to view the finished robot
    Alternatively, a facilitator can join the call on two separate devices, so that they
    may share the image through one of the two in the viewing room
  Ask for 4 volunteers: 1-2 to serve in the role of “writer” and 1-2 to serve in the role of
  “talker”. The rest of the group will be “builders”
    “Builders” are permitted to edit the assembly, but cannot see the robot key
    “Writers” are allowed to view the robot key in 30-second intervals. Once their time
    is up, they may type out their observations and send them into the chat with
    everyone. They are not allowed to talk or edit the assembly.
    “Talkers” are allowed to view the robot key in 30-second intervals. Once their time is
    up, they may verbally communicate their observations with the group. They are not
    allowed to type/write or edit the assembly.
  Share the editable disassembled robot document privately in the chat to the builders
  Have a facilitator share their screen so that the entire team can see the pieces. The
  builders can edit the page
    Additionally or alternatively, share a ‘view only’ link with the entire team, such that
    the builders have edit access, and everyone else can view the creation. This makes
    it easier for participants to see each other and the robot at the same time
  One facilitator will monitor the main room where the image of a finished robot is
  being displayed via screen sharing (a picture of the robot is shown in the Figures)
    Ensure no screen-shotting/phone pictures of the robot are taken
    Have at least 1 minute between each view by the writers and talkers
    If no facilitator monitoring the room, honor system for how long each person views
    the key
  Phase 1-No Planning Time
    Express to the team that there will be no planning time given until after the first
    talker returns
    The first “Writer” is sent to the viewing room for their allotted time
    Once they return, they may share their findings with the group
    The team may wait at least 1 minute before sending their talker
    The first “Talker” is sent to the viewing room for their allotted time
    Once they return, they may share their findings with the group
  Phase 2-Planning and Building
    At this point, allow the team 1-2 minutes to plan before sending their second
    writers and talkers
    The second “Writer” is sent to the viewing room for their allotted time
    Once they return, they may share their findings with the group
    The team may wait at least 1 minute before sending their talker
    The second “Talker” is sent to the viewing room for their allotted time
  Phase 3-Completing the Building
    At this point, the team may attempt to finish the build
    Remaining members may view robot assembly one at a time, for 15 seconds each
    Entire group may go together to view robot assembly for 30 seconds
    Writers or Talkers may be sent back for a second time with their given times
Virtual Tips/Notes:
  The transition from breakout room to main room and back takes a while. Plan for
  adequate transition time
  Each time someone new joins a Google drawing, a circle appears in the top right corner.
  This may be used to make sure that the writers/talkers do not cheat!
Platform Pros/Cons:
  WebEx and Zoom both work well with this activity given that you have an extra facilitator to
  join in the main room
  The double sign in may be used on WebEx.
```

### Experiential Activity: Virtual Card Pick Up

In the Virtual Card Pick Up experiential activity, the facilitator shares their screen with several cards with action statements on them. Some example statements may include: do the macarena, give your best Buzz Lightyear impression, introduce the group to a family member or roommate, or make up a poem. Each participant may then complete at least 3 actions, and indicate so by annotating their initials on the cards they have completed.

For example, for each participant 101-1 and participant computing device 102-1, local user input 103 may include action to select a card and/or action to annotate card corresponding to completed activity and local device output 105-1 may correspond to an annotated display of the cards. Each remote device output 105-2 may then correspond to the annotated display of the cards.

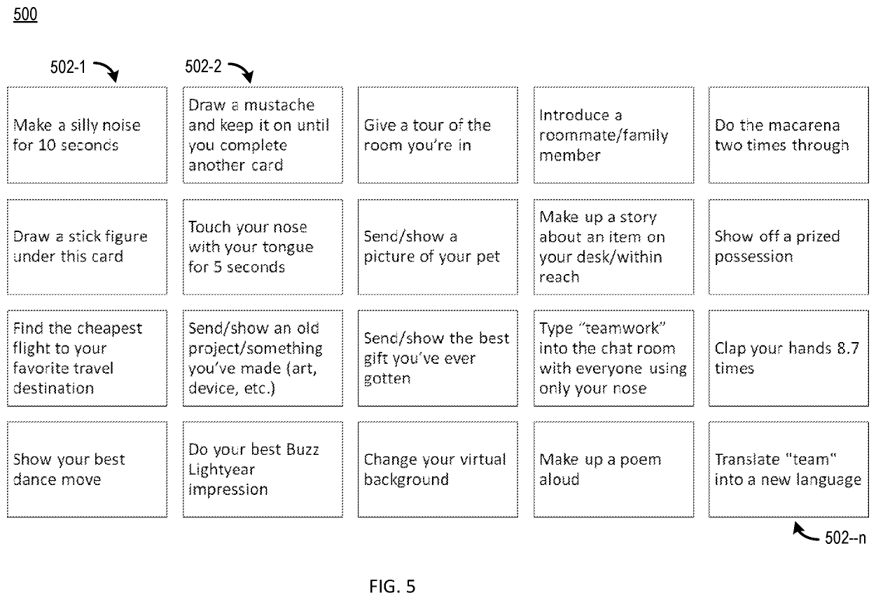

FIG. 5 illustrates an array 500 of cards, each card 502-1, 502-2, . . . , 502-n containing a unique activity, associated with a Virtual Card Pick Up activity, according to an embodiment of the present disclosure. For example, a first activity associated with a first card 502-1 is: Make a silly noise for 10 seconds. In another example, an nth activity associated with an nth card 502-n is: Translate “team” into a new language. However, this disclosure is not limited in this regard.

Table 7 includes a description of the Virtual Card Pick Up experiential activity, in the Experiential Activity descriptive format, as described herein.

TABLE 7
Experiential Activity: Virtual Card Pick Up

```
Goals: Icebreaker, teambuilding, common goal, get participants outside of their comfort zones
Breakout Room Size: 5-12
Time: 20-25 minutes
Virtual Platform: Zoom/WebEx
Facilitator Materials: Virtual Card Pick Up Cards (PPT)
Participant Materials: None
Set Up:
  Based on the number of participants, select which cards will be used in the pickup. Since
  everyone may do approximately 3 cards and all cards may be completed at least once, we
  suggest doubling the amount of cards per the amount of people in a group.
    For example, for a group of 10 people, we suggest using 20 cards.
    Pick a mix of outside comfort zone to pretty straightforward activities. The idea is
    to have a range of activities (example cards provided)
Directions:
  2*group size number of cards (facilitators use discretion based on the size of the group and
  the cards you choose to include in the “lineup”) will be displayed on the screen in each break
  out room with the activities/challenges face up
    Facilitator will share their screen of the cards (cards PPT (e.g., PowerPoint))
  Everyone may complete three cards
    Restrictions:
      Participants are free to choose any three cards shown on the screen
      All cards displayed are completed at least once
      A participant may not do the same card more than once
  Once a participant completes a card, they will initial it to show that they have done that card
    Participants may need to ‘request access’ to annotate
    Features are usually located on top bar
  The activity is over when all the cards are completed
  Race to complete them all (facilitator can decide whether to perform this activity in one
  large group and race against the clock or divide into teams that race against each other)
Variations:
  Points Style Competition
    This works well when there are multiple teams competing in separate breakout rooms
    Every card is worth a set number of points (e.g., the harder or more uncomfortable
    the card, the more points it may be worth)
    For each card completed, participants earn that number of points for their team
    The team with the most points at the end wins
  Time Competition
    Similar to above, but trying to complete the ‘card pick up’ in the shortest amount of
    time
Virtual Tips/Notes:
  Ensure facilitators are aware how to share screen and enable annotations
  Make sure that facilitators all have their own copy of the cards (offline) so that other
  facilitators do not edit them during the workshop
  The points style competition variation is suggested only for high-functioning teams who
  are comfortable being vulnerable in front of one another. It is recommended to remind
  participants of challenge by choice
Platform Pros/Cons:
  Both Zoom and WebEx Meetings support breakout rooms and sharing screen
    WebEx Meetings can handle annotations
```

### Experiential Activity: Link to Link

In the Link to Link experiential activity, participants are asked to brainstorm a couple random words or phrases. Examples may include, but are not limited to, lung, Spain, tennis ball, buffalo chicken wing. The facilitator will then select two words which have seemingly no relation to one another. One participant will share their web browser screen with the group. Starting on an online encyclopedia page (e.g., Wikipedia) for the first word, the group may then work together to navigate to the second word. The goal is to complete this path in as few clicks and as little time as possible.

For example, for each participant and participant computing device 102-1, local user input 103 may include spoken or typed words or phrases (UI 116 corresponding to microphone, and/or keyboard, keypad or touch sensitive display) and local device output 105-1 may correspond to a digital representation of the spoken or typed words or phrases. Each remote device output 105-2 may then correspond to the digital representation of the spoken or typed words or phrases. Subsequent local user inputs may then include, for example, mouse clicks or screen touches, to navigate the online encyclopedia.

Table 8A includes a description of the Link to Link experiential activity, in the Experiential Activity descriptive format, as described herein. Tables 8B and 8C include example easy Link to Link word pairs and example difficult Link to Link word pairs, respectively. However, this disclosure is not limited in this regard.

TABLE 8A
Experiential Activity: Link to Link

```
Goals: Icebreaker, Consensus Building
Breakout Room Size: 2-6
Time: 15 minutes
Virtual Platform: Zoom/WebEx
Facilitator Materials: Wikipedia
Participant Materials: Share Screen capability
Set Up:
  Turn on screen sharing for all participants
Directions:
  Have the team shout out two words (can be anything from parts of speech to brands,
  teams, celebrity names, etc.)
    One word will serve as the “start” and the other that will serve as the “finish”
    See example words below
  Before beginning, make sure both words have their own Wikipedia pages
    Example: there is no ‘chicken wing’ page, but the facilitator can suggest ‘Buffalo wing’
    as a confirmed page replacement
  Have one participant pull up the Wikipedia page corresponding to the start word
    This person should share their screen so the team is able to collaborate on which
    links to look for and use
  The goal of the activity is for the team to get from the start word to the finish word by
  only clicking links on the Wikipedia pages
  Rules (facilitator can restrict these for an added challenge):
    Participants cannot start a new wiki search or select the link to the main wiki page-
    they may start from the word provided and use links on the pages that they are
    redirected to
    Participants are allowed to go back
    Participants are allowed to use the “find on page” function (Ctrl + F)
Variations:
  Give the team a certain time limit to complete the task
    10 minutes is a good place to start
  Give the team a certain number of clicked links to complete the task
    7 clicks is a good place to start
Virtual Tips/Notes:
  Consider having different people share their screen each round to encourage participation
  and engagement
Platform Pros/Cons:
  May be tough for some people to participate if they are not as vocal as others in the group
  Awesome activity for linear-minded people. Consider extending the time for more
  creative thinkers
```

TABLE 8B
Link to Link (Easy)

| Word 1 | Word 2 |
|---|---|
| Pineapple | Boat |
| Squirrel | Octopus |
| Coffee | Spaghetti |
| Hair Tie | TikTok |

TABLE 8C
Link to Link (Difficult)

| Word 1 | Word 2 |
|---|---|
| Paper Clip | Battle of Gettysburg |
| Pokemon | NASCAR |
| Avatar the Last Airbender | Laplace Transform |
| Band-Aids | Video Games |

### Experiential Activity: Survey Says

In the Survey Says experiential activity, using a live polling platform, the facilitator will start a several question quiz with ranging types of questions asked. Some examples can include: hometown, major, favorite ice cream flavor, why they are here today, which is better: the book or the movie. For each question, the participants will submit their answers and the final results are displayed. The facilitator will debrief the results and moderate any discussion that comes about from the questions.

For example, for a facilitator and facilitator computing device 102-1, local user input 103 may include spoken or typed quiz questions (UI 116 corresponding to microphone, and/or keyboard, keypad or touch sensitive display) and local device output 105-1 may correspond to a digital representation of the spoken or typed quiz questions. Each remote device output 105-2 may then correspond to the digital representation of the spoken or typed quiz questions. For each participant and participant computing device, local user input may then include spoken or typed words or phrases corresponding to answers to the quiz questions (UI corresponding to microphone, and/or keyboard, keypad or touch sensitive display) and local device output may correspond to a digital representation of the answers to the quiz questions. The facilitator remote device output may then correspond to the digital representation of the spoken or typed words or phrases corresponding to the answers to the quiz questions. Subsequent facilitator local user input may then include, for example, polling results, corresponding to remote device output for participants. Subsequent participant local user input may then include spoken and/or typed comments regarding the polling results corresponding to remote device output for the facilitator and other participants.

Table 9 includes a description of the Survey Says experiential activity, in the Experiential Activity descriptive format, as described herein.

TABLE 9
Experiential Activity: Survey Says

```
Goals: Get to know each other, teambuilding
Breakout Room Size: 3-20 approximately, could be used for entire groups
Time: 15 minutes, can shorten or elongate if needed
Virtual Platform: WebEx/Zoom, Menti
    www.menti.com
    https://www.mentimeter.com/a
pp Facilitator Materials: Mentimeter
Survey
Participant Materials: Access to www.menti.com via phone or new tab
Set Up:
    Facilitator will create a survey on Mentimeter
    Questions can range in ‘get to know you’ level of intensity
    Facilitator will start the menti.com session and send the details to the group
Directions:
    Have each participant go to www.menti.com on their phones (if no phone, new tab)
    Enter the appropriate code (unique to menti presentation): XX XX XX X
    Facilitator will share their screen with the live results and polling feature
    Have participants ‘vote’ for their best answer to each question
    Share results with group, allow time for people to react and question
      The facilitator decides how long to spend on each result, if people are
      appalled or shocked, can ask for some people to explain their answers
Virtual Tips/Notes:
    It's suggested for the facilitator to have good rapport with the group to keep things
    moving along. This activity depends on the ‘art of facilitating’ and sensing when to pry for
    more information or let people debate a question, or move onto the next question or
    activity
Platform Pros/Cons:
    Zoom, WebEx: share screen capability
    Mentimeter: FREE version allows for approximately 7-8 questions. The pro version (paid)
    allows an unlimited number of questions.
Sample Prompts:
  What is your favorite caffeinated beverage? What is better: the movie or the book?
  Is water wet?
  What is the best flavor of ice cream? What is the best place to vacation?
  What is one word to describe how you're feeling for this facilitation?
```

### Experiential Activity: Take a Stand

In the Take a Stand experiential activity, the facilitator will read through a list of prompts that participants can either agree or disagree on. Some examples of prompts include: I prefer Netflix over Hulu. I am from New York. If a participant agrees with a statement, they may then stand up. If a participant disagrees with a statement, they will remain sitting. The facilitator will debrief the results and moderate any discussion that comes about from the statements and participant's opinions.

For example, for a facilitator and facilitator computing device 102-1, local user input 103 may include the spoken prompts (UI 116 corresponding to microphone) and local device output 105-1 may correspond to a digital representation of the spoken prompts. Each remote device output 105-2 may then correspond to the digital representation of the spoken prompts. For each participant and participant computing device, local user input may then include captured image (UI corresponding to camera) of participant position (i.e., standing, sitting or some other gesture) and local device output may correspond to a digital representation of the image. The facilitator remote device output may then correspond to the digital representation of participant gestures. Subsequent facilitator local user input may then include, for example, spoken or typed words or phrases corresponding to answers to the results (UI corresponding to microphone, and/or keyboard, keypad or touch sensitive display), corresponding to remote device output for participants. Subsequent participant local user input may then include spoken and/or typed comments regarding the results corresponding to remote device output for the facilitator and other participants.

Table 10A includes a description of the Take a Stand experiential activity, in the Experiential Activity descriptive format, as described herein. Table 10B includes example prompts. However, this disclosure is not limited in this regard.

TABLE 10A
Experiential Activity: Take a Stand

```
Goals: Teambuilding, Get to know you, icebreaker, energizer
Breakout Room Size: 6-22 (limited by # of participants on 1 screen on a call)
Time: 15 minutes
Virtual Platform: Zoom/WebEx
Facilitator Materials: Camera, List of statements
Participant Materials: Camera
Set Up:
  Facilitator will create appropriate list of statements based off of people's experiences, values,
  opinions, etc.
Directions:
  Facilitator will read through a list of statements
  If the statement applies to the participant, they should stand up
  If any participants do not have camera access, they can ‘raise hand’ in the virtual setting
Variations:
  Have one participant say a fact about themselves. Other participants may stand if that
  statement also applies to them. Then have the first participant popcorn to someone standing,
  who may then share a new fact.
Virtual Tips/Notes:
  Request participants angle their camera to fit both their face and bodies in the frame
    Ask everyone to stand further away from the screen
  Statements should be all-inclusive
    Example: avoid questions about expensive technology (“Hulu is my favorite
    streaming service” or “iPhones are better than Androids”)
Platform Pros/Cons:
  Zoom, WebEx: Facilitator may teach participants where ‘hand raising’ tool is
  May be difficult to promote ‘standing’, facilitator's choice to change this to ‘Take a Seat’ or
  some other visible gesture
```

TABLE 10B
Take a Stand

| | | |
|---|---|---|
| I live in New York | I'm excited for the upcoming | I am involved in Student |
| | semester | Government |
| I play a musical | My favorite dining hall is | This is my first year at school |
| instrument | Commons | |
| I play a sport | I've pulled an all-nighter at school | I prefer hamburgers over |
| | | hotdogs |
| I've been to the beach | I've been to the Farmer's Market | I am still friends with my |
| before | | roommate from freshman year |
| I am a member of a | I prefer studying in the Library over | I am an engineering major |
| Greek Life | my bedroom | |
| I went on a hike this | I prefer Ben and Jerry's ice cream | Homemade mac n cheese is |
| summer | over hand-scooped ice cream | better than Kraft |
| I've traveled outside the | I participated in a LEAP event | I like cats more than dogs |
| US | before | |

### Experiential Activity: Straw Stacker

In the Straw Stacker experiential activity, participants create and place rectangles (i.e., straws, that may also be of different colors) to match a pattern given by the facilitator. As the pattern contains overlapping pieces, participants determine the proper order so that each piece can be laid down without being moved after.

For example, for each participant and participant computing device, local user input may include action to select and place a “straw” and local device output may correspond to the selection and placement. Each remote device output may then correspond to the drawing of the stack of straws that includes the user inputs.

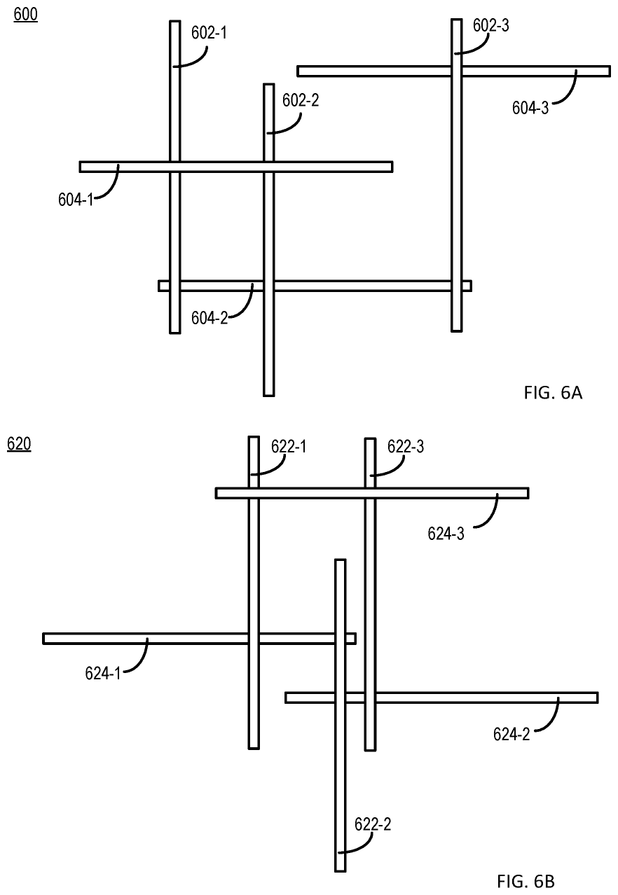

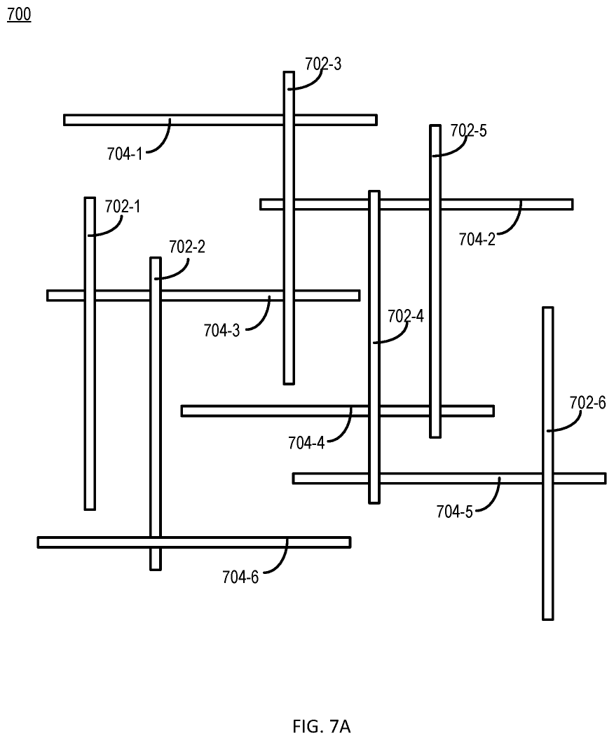

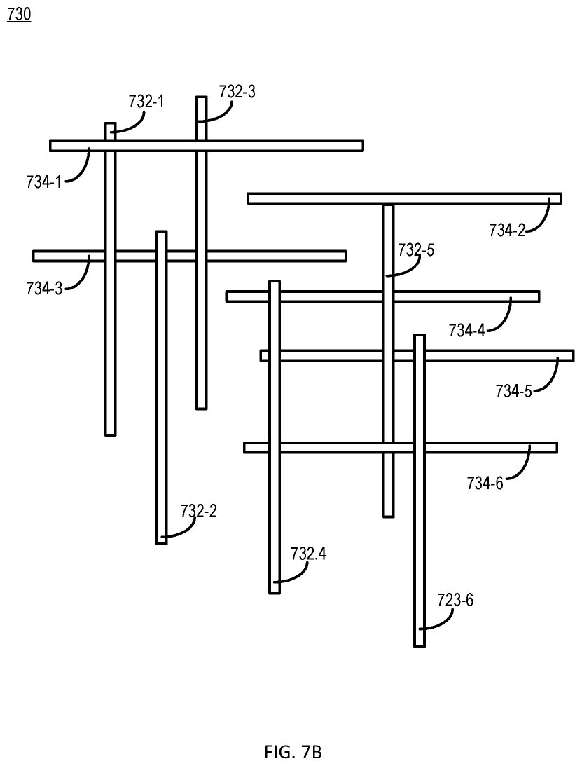

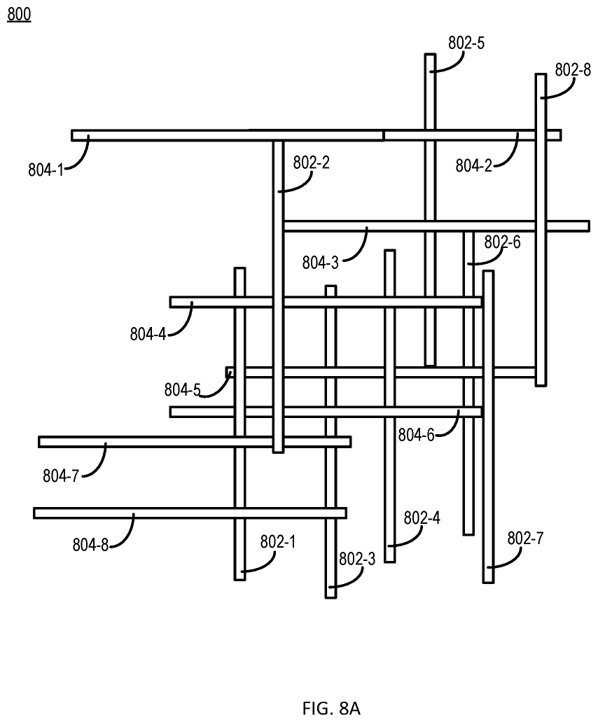

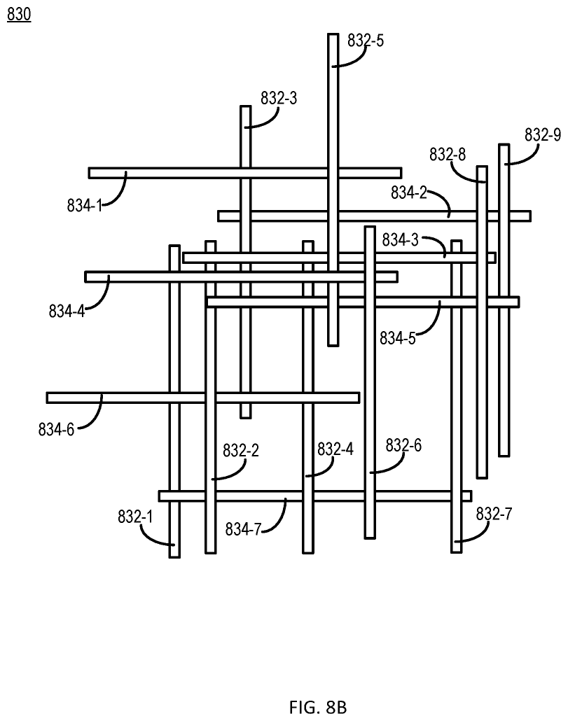

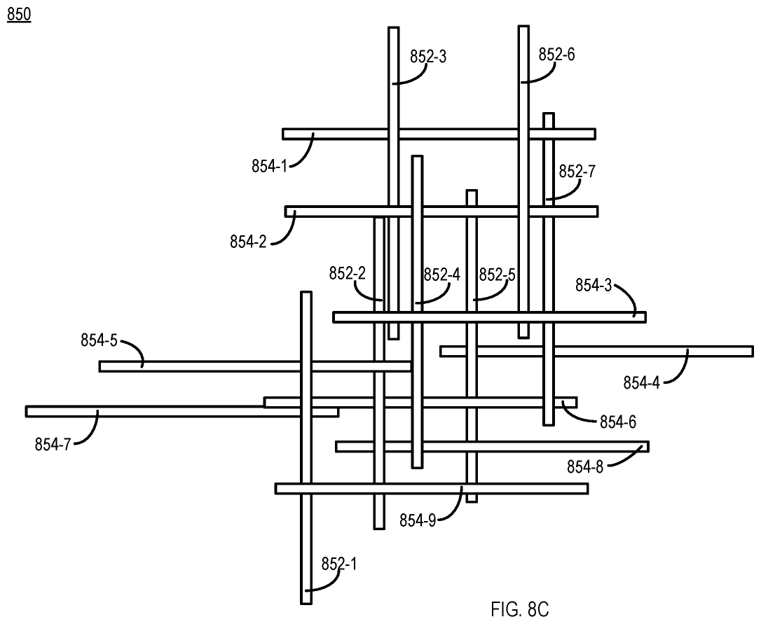

FIGS. 6A and 6B illustrate relatively easy example puzzles 600, 620 associated with a Straw Stacker activity, according to an embodiment of the present disclosure. FIGS. 7A and 7B illustrate example puzzles 700, 730 of medium complexity associated with the Straw Stacker activity, according to an embodiment of the present disclosure. FIGS. 8A through 8C illustrate relatively difficult example puzzles 800, 830, 850 associated with a Straw Stacker activity, according to an embodiment of the present disclosure.

Each puzzle 600, 620, 700, 730, 800, 830, 850 includes a number of rectangles corresponding to “straws” as described in the Straw Stacker activity. The number of straws ranges from six to sixteen. However, this disclosure is not limited in this regard. Each straw may be a respective color and/or may have a respective fill pattern. In these examples, each straw is oriented either vertically or horizontally. However, this disclosure is not limited in this regard. In the following description, stacking is described as layers, with a first layer corresponding to a bottom layer and a last layer corresponds to a top layer. However, this disclosure is not limited in this regard. It may be appreciated that an order of placement of straws that do not overlap (i.e., within a layer) may not be unique. In other words, the order of placement for overlapping straws is constrained while the order of placement of straws that do not overlap, i.e., that are within a same layer, may not be constrained with respect to other straws in the layer.

Turning first to FIG. 6A, FIG. 6A illustrates a relatively easy example straw puzzle 600, that includes six straws 602-1, 602-2, 602-3, 604-1, 604-2, 604-3. A first layer includes straws 604-2 and 604-3. A second layer includes straws 602-1, 602-2, and 602-3. A third layer includes straw 604-1.

FIG. 6B illustrates another relatively easy example straw puzzle 620, that includes six straws 622-1, 622-2, 622-3, 624-1, 624-2, 624-3. A first layer includes straws 624-1 and 624-1. A second layer includes straws 622-1, 622-2, and 622-3. A third layer includes straw 624-3.

FIG. 7A illustrates an example puzzle 700 of medium complexity, that includes twelve straws 702-1, . . . , 702-6, 704-1, . . . , 704-6. A first layer includes straws 704-1, 704-2, 704-3, 704-4, and 704-5. A second layer includes straws 702-1, 702-2, 702-3, 702-4, 702-5, 702-6. A third layer includes straw 704-6.

FIG. 7B illustrates another example puzzle 730 of medium complexity, that includes twelve straws 732-1, . . . , 732-6, 734-1, . . . , 734-6. A first layer includes straws 734-2, 734-3, 734-4, and 734-5. A second layer includes straws 732-1, 732-2, 732-3, and 732-5. A third layer includes straws 734-1, and 734-6. A fourth layer includes straws 732-4, and 732-6.

FIGS. 8A through 8C illustrate relatively difficult example puzzles 800, 830, 850, that each includes 16 straws. FIG. 8A illustrates a first relatively difficult example puzzle 800 that includes straws 802-1, . . . , 802-8, and 804-1, . . . , 804-8. A first layer includes straws 802-3, 802-5, and 802-6. A second layer includes straws 804-2, 804-3, and 804-5. A third layer includes straws 804-1, 802-8, 802-7, and 802-4. A fourth layer includes straw 804-6. A fifth layer includes straw 802-1. A sixth layer includes straws 804-4, 804-7, and 804-8. A seventh layer includes straw 802-2.

FIG. 8B illustrates a first relatively difficult example puzzle 830 that includes straws 832-1, . . . , 832-9, and 834-1, . . . , 834-7. A first layer includes straws 832-1, and 834-2. A second layer includes straws 834-7, 832-9, and 832-3. A third layer includes straws 832-2, 832-4, 832-7, and 834-1. A fourth layer includes straws 834-5, 834-3, and 834-6. A fifth layer includes straws 832-5, 832-8, and 834-4. A sixth layer includes straw 832-6.

FIG. 8C illustrates a first relatively difficult example puzzle 850 that includes straws 852-1, . . . , 852-7, and 854-1, . . . , 854-9. A first layer includes straws 854-4, and 854-7. A second layer includes straw 852-5. A third layer includes straws 854-8, and 854-6. A fourth layer includes straws 852-7, and 852-2. A fifth layer includes straws 854-5, and 854-1. A sixth layer includes straws 852-1, and 852-3. A seventh layer includes straws 854-9, and 854-2. An eighth layer includes straws 852-6, and 852-4. A ninth layer includes straw 854-3.

Table 11 includes a description of the Straw Stacker experiential activity, in the Experiential Activity descriptive format, as described herein.

TABLE 11
Experiential Activity: Straw Stacker

```
Goals: Communication, teamwork, problem solving, goal setting, teambuilding
Breakout Room Size: 5-10
Time: 30 minutes
Virtual Platform: Zoom/WebEx, Google Drawings
Facilitator Materials: Google Drawing straw keys
Participant Materials: Access to Google Drawings
Set Up:
  Before the workshop, create a new google drawing and copy/paste one puzzle for each group
    Sample template:
    (https://docs.google.com/drawings/d/1nCYQ_gFUbofjXqIJ9YINIP4IGJIVP_3DdBZ7tX
    NYL Xw/edit)
    Confirm that all participants have edit access
Directions:
  Each puzzle has a number (e.g., 6 to 16, depending on complexity) “straws” placed on top of
  each other in different orders and locations. As a team, the group is to replicate the puzzle.
  The straws are sticky, so once another straw is on top, the lower straws can't move
  Rules:
    Participants may use the rectangle tool
    Participants may change the color of their straws (“repainting them”).
    They cannot use the “order” setting option to change the layer a straw is on.
    Facilitators can enforce this by watching the Google drawing screen and group
    Only straws without other straws on top of them can be moved
    To complete the challenge, the correctly colored straws should be in the right
    order and position
    If the team makes a mistake, they may backtrack and delete everything following
    the mistake. (Example: if the order should be ABCDE, but they accidentally do
    ACBDE, they delete CBDE)
  Facilitators: time the team and challenge them to beat their previous times. After the first
  round, you can allow them to “put away” the boards in a stack to the side, then solve the
  puzzle again.
  If they have trouble, the facilitator can add some modifications (one at a time or
  multiple together):
    Suggest for the team to take 5 minutes to plan first
    Allow them to move any straws
    Allow them to use the order function
    Switch to an easier puzzle
  Additional rules for later rounds (one at a time or both):
    Once placed, the straws cannot be moved
    Once placed, the straws cannot be repainted
    Try a new puzzle
Virtual Tips/Notes:
  Suggest participants format their screens to see both the Virtual Platform/their teammates
  and the Google Drawing with the boards.
Platform Pros/Cons:
  Both WebEx and Zoom work with this
```

### Experiential Activity: Stranded in Quarantine

In the Stranded in Quarantine experiential activity, participants are asked to choose 5 items from a list to use for the entirety of their quarantine. Then, as a development of consensus building skills, the entire team chooses items to share.

For example, for a facilitator and facilitator computing device, local user input may include a document including a list of items or a typed list of items (UI corresponding to mouse, and/or keyboard, keypad or touch sensitive display) and local device output may correspond to a digital representation of the list of items. Each remote device output may then correspond to the digital representation of the list of items. For each participant and participant computing device, local user input may then include a participant ranked list of selected items from the list of items (UI corresponding to mouse, and/or keyboard, keypad or touch sensitive display) and local device output may correspond to a digital representation of the participant ranked list of selected items. The facilitator remote device output may then correspond to the digital representation of the participant ranked list of selected items. Subsequent participant local user input may then include spoken and/or typed comments regarding a group ranking items corresponding to remote device output for the facilitator and other participants.

Table 12A includes a description of the Stranded in Quarantine experiential activity, in the Experiential Activity descriptive format, as described herein. Table 12B includes example Stranded in Quarantine possible items. However, this disclosure is not limited in this regard. In some embodiments, pictures of the items may also be included.

TABLE 12A
Experiential Activity: Stranded in Quarantine

```
Goals: Consensus building, teambuilding, problem solving, goal setting
Breakout Room Size: 5-12
Time: 20 minutes
Virtual Platform: Zoom/WebEx
Facilitator Materials: List of items, scenario, Google document file to share with group
Participant Materials: Pencil/Paper or text file to write
Set Up:
  Scenario: You're coming back to a school's spring semester, and the shuttle taking you to
  campus crashes, sending your stuff tumbling into a passing garbage truck. As a group,
  you have enough money to buy 5 items from the store quickly before your 2 week
  quarantine in a dorm building together starts. You're already stocked with the necessities
  to survive, but how do you prepare for the incoming boredom?
  Post list of 20 items by sharing screen with Power Point slide (with images of the items)
  List of items:
    Tennis ball, deck of cards, magic 8 ball, Venus fly trap, Lego set, 1000 piece puzzle,
    paints, ream of printer paper, walkie talkie set, two 20 lb hand weights, a bowling
    ball, a Rubik's cube, a yo-yo, 3 paperback books, a Nintendo DS or Gameboy, iPod
    Nano, board game, landline telephone, 5 movies, cable TV
  Optional: can make a Google document with all the items listed for the group to get on and
  edit together(or make individual copies of for the individual portion of the activity)
Directions:
  Everyone is given 2 minutes to individually rank their top 5 items
  As a group, create one group ranking of 5 items for the entire group to share
    For example: The group may decide that everyone will be quarantined with 3
    books, a bowling ball, a deck of cards, a Lego set, and an iPod nano. This means in
    the scenario, everyone will share these items in one quarantine setting.
Variations:
  For a slightly easier challenge, have the group instead decide on 5 items that each
  member of the team will receive
    Example: The group may decide that everyone will be quarantined with 3 books, a
    bowling ball, a deck of cards, a lego set, and an iPod nano. In the scenario, everyone
    will thus individually receive these items to quarantine with.
Virtual Tips/Notes:
  All participants sharing their individually chosen items with the group may take a large
  amount of time on the virtual platform, plan ahead for this
Platform Pros/Cons:
  Because this is mainly a discussion-based activity, there are no platforms that are
  preferred. Whichever one has more reliable internet connections.
```

TABLE 12B
Stranded in Quarantine

| | | |
|---|---|---|
| Tennis ball | Ream of printer paper | Nintendo DS/Gameboy |
| Deck of cards | Walkie talkie set | iPod Nano |
| Magic 8 ball | Two 20 pound weights | Three board games |
| Venus fly trap | Bowling ball | Landline telephone |
| Lego set | Rubik's cube | Five movies |
| 1000 piece puzzle | Yo-yo | Cable TV |
| Painting supplies | Three paperback books | Hula hoop |

### Experiential Activity: Codebreaker

In the Codebreaker experiential activity, the facilitator privately messages 1-5 gibberish words and the English translations to each participant. Then, the facilitator shares a phrase entirely in gibberish which the group may translate based on the translations they were each sent. The goal is to successfully and completely translate the gibberish phrase to English.

For example, from the perspective of a facilitator computing device, a local user input includes entry, by the facilitator (using, for example, a keyboard, keypad or a touch sensitive display as the UI), of text that includes one to five gibberish words and corresponding English translation. A corresponding local device output may be a digital representation of the characters corresponding to the text. For a selected participant computing device, a remote device output may then be a digital representation of characters corresponding to text provided by the facilitator. The digital representation of characters corresponding to the text may be processed and the alphanumeric description may be provided to the participant visually using a display. Subsequently, continuing with the facilitator, the operations may be repeated for a gibberish phrase that is to be translated. The corresponding local device output may then be provided to all participant computing devices.

For each participant and participant computing device, local user input may then include a spoken or typed translation of a selected word in the gibberish phrase (UI corresponding to microphone, and/or keyboard, keypad or touch sensitive display) and local device output may correspond to a digital representation of the participant spoken translation. The remote device output may then correspond to the digital representation of the spoken translation. Subsequent participant local user input may then include additional spoken and/or typed translations of selected words in the gibberish phrase.

Table 13A includes a description of the Codebreaker experiential activity, in the Experiential Activity descriptive format, as described herein. Table 13B includes several example Codebreaker phrase pairs, ranging from 5 words to 114 words. However, this disclosure is not limited in this regard. In Table 13B, the phrase is provided in plaintext, followed by the same phrase in gibberish, followed by a listing of corresponding gibberish-plaintext word pairs.

TABLE 13A
Experiential Activity: Codebreaker

```
Goals: Teambuilding, communication, goal setting
Breakout Room Size: 5-12
Time: 20-30 minutes
Virtual Platform: Zoom/WebEx
Facilitator Materials: List of encrypted and deciphered codes
Participant Materials: None
Set Up:
    Storylines:
        A text file was corrupted and it's up to the team to decrypt it
        A secret message was intercepted and it's up to the team to decipher it
Directions:
    Participants will individually be given gibberish words and its translation. The team may
    work together to decipher a message made of entirely gibberish words.
    The facilitator will first send the complete ciphered text to everyone in the chat
    Then, the facilitator will send each person the translation to a gibberish word via
    private message
        For example: “gislf” = “work”, and “andfu” = “together”
        For longer phrases, send each person multiple words
          Divide the words into roughly equal parts depending on the number of people
    Participants will “translate” or “decode” the paragraph by having each team member say their
    assigned word when the group reaches it
        For example: “gislf andfu forfs brorb hopop” = “work together to accomplish more”
    Rules
        No writing down the words, no online resources, no discussing their words, no
        taking pictures
        Other than these restrictions, they can strategize and communicate normally
    Challenge participants to complete the phrase as fast as possible
        Round 1-No timing
        Later rounds-can add timing goals to facilitator's discretion
    Once they successfully read the paragraph, show the plaintext
Variations:
    Can have participants repeat the final phrase out loud to everyone, as fast as they can
Virtual Tips/Notes:
    This activity is copy/paste heavy and facilitator based, be prepared to be involved in the activity
    It is suggested to find other things the group can discuss or work on while facilitator assigns
    the translations to each participant
Platform Pros/Cons:
  Zoom effectively mutes other participants when one is talking, but won't always pick up if it's a
  short phrase or word or others are talking over each other
      It is suggested for the facilitator to assist and report back if any participants weren't
      heard well
```

TABLE 13B
Code Breaker Sample Phrases
Word count: 5
Phrase: “Positive energy knows no boundaries.”-Lu Wei
Ciphered Phrase: “icodx pims cifhuu ceeoen mnare.”

| | |
|---|---|
| ceeoen: no | pims: energy |
| mnare: boundaries | cifhuu: knows |
| icodx: positive | |

Word count: 5
“Be visionary about your goals.”-Sayam Asjad
“deufo trat tidtu dvon hnoasa.”

| | |
|---|---|
| hnoasa: goals | deufo: be |
| dvon: your | trat: visionary |
| tidtu: about | |

Word count: 6
Change the world by being yourself.-Amy Poehler
icsuni siand maooge aevao loef mmisto.

| | |
|---|---|
| aevao: by | icsuni: change |
| maooge: world | loef: being |
| mmisto: yourself | siand: the |

Word count: 7
“A goal properly set is halfway reached.”-Zig Ziglar
“trihea sregs bietta herrerbnoo fnaoy tyusro.”

| | |
|---|---|
| fnaoy: halfway | bnoo: is |
| trihea: a | bietta: properly |
| herrer: set | tyusro: reached |
| sregs: goal | |

Word count: 8
“A goal is a dream with a deadline.”-Napoleon Hill
“tnii wiuo wuuwes pepf oelgu hagt bufele neotoa.”

| | |
|---|---|
| wiuo: goal | bufele: a |
| pepf: a | neotoa: deadline |
| tnii: a | oelgu: dream |
| hagt: with | wuuwes: is |

Word count: 11
Identify your problems, but give your power and energy to solutions.-Tony Robbins
toop nyiyre maroc, ooogn tnan ivalt loit bmer nids mmaa vils.

| | |
|---|---|
| loit: power | mmaa: to |
| tnan: give | toop: identify |
| bmer: and | vils: solutions |
| nids: energy | maroc: problems |
| ooogn: but | nyiyre: your |
| ivalt: your | |

Word count: 13
“Shoot for the moon. Even if you miss, you'll land among the stars.”-Norman Vincent Peale
“corha srif forta cnanf. tlao tesee sses ttud, mrirvo tvewno didut disoh iioe.”

| | |
|---|---|
| tvewno: land | srif: for |
| disoh: the | forta: the |
| ttud: miss | didut: among |
| iioe: stars | tesee: if |
| cnanf: moon | tlao: even |
| mrirvo: you'll | corha: shoot |
| sses: you | |

Word count: 18
“A goal is not always meant to be reached; it often serves simply as something to aim at.”-Bruce Lee
ttehatsin curego dinahe botiwe chiin aetfi tsurra witaa; this matn iisnie duhd oihteitisle
wetaowdor ssain.

| | | |
|---|---|---|
| ssain: at | tsurra: be | matn: often |
| dinahe: not | oihtei: as | curego: is |
| tsin: goal | weta: to | owdor: aim |
| tisle: something | botiwe: always | witaa: reached |
| aetfi: to | iisnie: serves | duhd: simply |
| chiin: meant | tteha: a | this: it |

Word count: 20
You have brains in your head. You have feet in your shoes. You can steer yourself any direction
you choose.-Dr. Seuss
oneoaitsowb criyr hiwiaa hewidapeiph. torit setoo tnaoh wnetce sceoiceiu. coters aobt wielteos
csue srat tegn ddolah.

| | | | |
|---|---|---|---|
| wnetce: in | teos: yourself | tegn: you | itsowb: have |
| sceoi: your | hiwiaa: in | torit:you | csue: any |
| hewida: your | aobt: can | tnaoh: feet | setoo: have |
| criyr: brains | oneoa: you | wlel: steer | peiph: head |
| srat: direction | coters: you | ceiu: shoes | ddolah: choose |

Word count: 22
“Real courage is when you know you're licked before you begin, but you begin anyway and see
it through no matter what.”-To Kill a Mockingbird, Harper Lee
“renhi haigee rute uriw ietl sifhei ilony cetg wene hnun maofn, oeudyiseuss reieer onrat
tlunseeafd ohpern ceaait iate tuta rwud.”

| | | | |
|---|---|---|---|
| uriw: when | iate: no | eafd: see | tlunse: and |
| rute: is | reieer: begin | ilony: you're | hnun: you |
| wene: before | rwud: what | sifhei: know | ceaait: through |
| haigee: courage | cetg: licked | seuss: you | onrat: anyway |
| maofn: begin | ietl: you | ohpern: it | tuta: matter |
| oeudyi: but | renhi: real | | |

Word count: 29
“The great danger for most of us lies not in setting our aim too high and falling short; but in
setting our aim too low, and achieving our mark.”-Michelangelo
hraloy pteo wyuuainno cutr wruu tsewracohaib hnersluy staae ybedfo toorp tosmia ttoh
wirivtaulge ttoris; sammoh tibei toeop bnaw indi weti plohto, ikaf tnov weripo ptimp.

| | | | |
|---|---|---|---|
| toorp: aim | sammoh: but | tosmia: too | sluy: in |
| hraloy: the | indi: aim | bnaw: our | cutr: most |
| hner: not | wiriv: and | tibei: in | cohaib: lies |
| tsewra: us | ttoh: high | ptimp: mark | ybedro: our |
| inno: for | tnov: achieving | toeop: setting | staae: setting |
| weti: too | wruu: of | ikaf: and | |
| ttoris: short | weripo: our | taulge: falling | |
| plohto: low | wyuua: danger | pteo: great | |

Word count: 114
Sonnet 18
Shall I compare thee to a summer's day?
Thou art more lovely and more temperate:
Rough winds do shake the darling buds of May,
And summer's lease hath all too short a date:
Sometime too hot the eye of heaven shines,
And often is his gold complexion dimm'd;
And every fair from fair sometime declines,
By chance or nature's changing course untrimm'd;
But thy eternal summer shall not fade
Nor lose possession of that fair thou owest;
Nor shall Death brag thou wander'st in his shade,
When in eternal lines to time thou growest:
So long as men can breathe or eyes can see,
So long lives this and this gives life to thee.
tetheo sulet tsea saed lnase tkolmu tesaus tocfoi?
panwor jnie biwah wirahe dnes lolh wkun:
oiae pareg dledie ottat qvaow titgan yeeoet daasta ifeeee,
fuaak crul thet wols pweo tupei dyus tanafi tsit:
lnarh snehu emna sitce haalil eyrino oieo armeyr,
creub iice rennu teif ahia aasco vorcea;
brio ceiapt vuoa woaoh crot thopta ifbots,
tmop csagho intu wilpae goew kair hnuag;
cedro oslo csoind ttita iimna rmedgi topmuh
rgura tadfon sner aeen pifo oaii hohlo ttewik;
syaiaw pteis doht gmiku pwoadi traode smoen ifao dlaro,
tary psui wloe ceogg pneuva isceto ohno oreoer:
ckawco melc reyo ptafna haoe chug esar ptipt tteuor eirrei,
casna thes zenm geip ytua wiitil fihe rrot meeas nosdel.

| | | | | |
|---|---|---|---|---|
| wilpae: nature's | csoind: eternal | chug: breathe | dyus: short | thopta: sometime |
| pareg: winds | tetheo: shall | pwoadi: thou | rmedgi: not | pneuva: to |
| vorcea: dimm'd | psui: in | oslo: thy | qvaow: the | csagho: chance |
| tanafi: a | panwor: thou | hohlo: thou | ifeeee: may | titgan: darling |
| ceiapt: every | fuaak: and | sitce: the | sulet: i | biwah: more |
| daasta: of | iice: often | oaii: fair | ytua: and | wloe: eternal |
| tocfoi: day | haalil: eye | oiae: rough | iimna: shall | dnes: and |
| tadfon: lose | geip: this | ifao: his | tsea: compare | wols: hath |
| armeyr: shines | crot: fair | tteuor: can | meeas: to | ptafna: men |
| teif: his | smoen: in | tary: when | snehu: too | ifbots: declines |
| cedro: but | tupei: too | rgura: nor | ohno: thou | aasco: complexion |
| isceto: time | ckawco: so | gmiku: brag | ttewik: owest | melc: long |
| lolh: more | woaoh: from | ptipt: eyes | wkun: temperate | intu: or |
| esar: or | aeen: of | eirrei: see | saed: thee | tesaus: summer's |
| goew: changing | rrot: life | ottat: shake | lnase: to | nosdel: thee |
| wirahe: lovely | eyrino: of | ceogg: lines | brio: and | yeeoet: buds |
| topmuh: fade | rennu: is | vuoa: fair | doht: death | casna: so |
| hnuag: untrimm'd | lnarh: sometime | tmop: by | crul: summer's | thet: lease |
| dlaro: shade | haoe: can | kair: course | sner: possession | zenm: lives |
| pweo: all | oieo: heaven | syaiaw: nor | thes: long | ahia: gold |
| pteis: shall | fihe: gives | jnie: art | wiitil: this | oreoer: growest |
| dledie: do | emna: hot | reyo: as | pifo: that | tkolmu: a |
| traode: wander'st | ttita: summer | creub: and | tsit: date | |

Thus, experiential teambuilding activities may be performed remotely, using an apparatus, system and/or method, as described herein. A local participant and one or more remote participants may be coupled using, for example, experiential activities system 100 of FIG. 1. The participants may then participate in remote experiential activities utilizing experiential activities system 100. The remote experiential activities, as described herein, are configured to be engaging for the participants, in the remote environment.

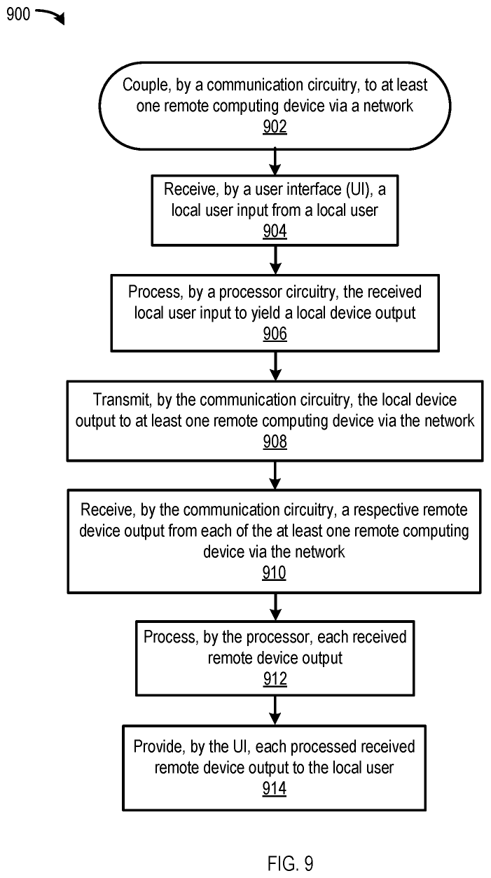

FIG. 9 is a flowchart 900 of example experiential activities operations consistent with several embodiments of the present disclosure. In particular, the flowchart 900 illustrates facilitating remote experiential teambuilding activities. The operations of flowchart 900 may be performed by, for example, one or more computing device(s) 102-1, 102-2, . . . , 102-n (e.g., processor circuitry 110, communication circuitry 114 and/or UI 116) of FIG. 1.

Operations of flowchart 900 may begin with coupling, by a communication circuitry, to at least one remote computing device via a network at operation 902. Operation 904 may include receiving, by a user interface (UI), a local user input from a local user. The local user input may be associated with a remote experiential teambuilding activity. Operation 906 may include processing, by a processor circuitry, the received local user input to yield a local device output. Operation 908 may include transmitting, by the communication circuitry, the local device output to at least one remote computing device via the network. Operation 910 may include receiving, by the communication circuitry, a respective remote device output from each of the at least one remote computing device via the network. Each remote device output may be associated with the remote experiential teambuilding activity. Operation 912 may include processing, by the processor, each received remote device output. Operation 914 may include providing, by the UI, each processed received remote device output to the local user. The local user input and remote device output are associated with a selected experiential activity.

Thus, a computing device may be configured to facilitate participation of remotely located participants in experiential activities, according to the present disclosure.

As used in any embodiment herein, the term “module” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may include, for example, singly or in any combination, hardwired circuitry, programmable circuitry such as computer processors including one or more individual instruction processing cores, state machine circuitry, and/or firmware that stores instructions executed by programmable circuitry. The logic may, collectively or individually, be embodied as circuitry that forms part of a larger system, for example, an integrated circuit (IC), an application-specific integrated circuit (ASIC), a field-programmable gate array (FPGA), a programmable logic device (PLD), a complex programmable logic device (CPLD), a system on-chip (SoC), etc.

Memory circuitry 112 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively memory circuitry 112 may include other and/or later-developed types of computer-readable memory.

Embodiments of the operations described herein may be implemented in a computer-readable storage device, e.g., storage 118, having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A computing device for remote experiential teambuilding activities, the computing device comprising:
a communication circuitry configured to couple to a remote computing device via a network, the remote computing device associated with a remote participant; and
a user interface (UI) configured to receive a local user input from a local participant, and to provide at least one of a local device output or a remote device output to the local participant, the local user input, local device output and remote device output related to a selected experiential activity.

2. The computing device of claim 1, wherein the selected experiential activity is selected from the group comprising Team Tapestry, Human Mirror, Me-Moji, Ship Shape, Fact or Fiction, Robot Assembly, Virtual Card Pick-Up, Link to Link, Survey Says, Take a Stand, Straw Stacker, Stranded in Quarantine and Codebreaker.

3. The computing device of claim 1, further comprising storage configured to store a plurality of modules, each module corresponding to a selected off-the-shelf application or program.

4. The computing device of claim 1, wherein the UI comprises one or more of a camera, a microphone, and/or a loudspeaker, and is configured to facilitate engagement of the local participant in the experiential activity in a virtual environment.

5. The computing device of claim 3, wherein each module is selected from the group comprising a web browser, a search engine, a virtual platform configured to facilitate remote video communication, a game-based learning platform, an online encyclopedia, a chat application, a messaging application, a drawing application, a live polling platform, a website that provides digital images “emojis” used to express emotion, an application with forms, and/or a presentation application.

6. The computing device of claim 1, wherein the selected experiential activity comprises a plurality of levels of difficulty.

7. The computing device of claim 1, wherein each experiential activity has an associated goal, the associated goal selected from the group comprising self-reflection, getting to know people, trust building, team building, communication, conflict resolution, ice breaking, group bonding, problem solving, teamwork, group dynamics, common goal, get participants outside of their comfort zones, consensus building, energizer, and goal setting.

8. A method for remote experiential teambuilding activities, the method comprising:
coupling, by a communication circuitry, to a remote computing device via a network, the remote computing device associated with a remote participant;
receiving, by a user interface (UI), a local user input from a local participant; and
providing, by the UI, at least one of a local device output or a remote device output to the local participant, the local user input, local device output and remote device output related to a selected experiential activity.

9. The method of claim 8, wherein the selected experiential activity is selected from the group comprising Team Tapestry, Human Mirror, Me-Moji, Ship Shape, Fact or Fiction, Robot Assembly, Virtual Card Pick-Up, Link to Link, Survey Says, Take a Stand, Straw Stacker, Stranded in Quarantine and Codebreaker.

10. The method of claim 8, further comprising storing, by storage, a plurality of modules, each module corresponding to a selected off-the-shelf application or program.

11. The method of claim 8, wherein the UI comprises one or more of a camera, a microphone, and/or a loudspeaker, and is configured to facilitate engagement of the local participant in the experiential activity in a virtual environment.

12. The method of claim 10, wherein each module is selected from the group comprising a web browser, a search engine, a virtual platform configured to facilitate remote video communication, a game-based learning platform, an online encyclopedia, a chat application, a messaging application, a drawing application, a live polling platform, a website that provides digital images “emojis” used to express emotion, an application with forms, and/or a presentation application.

13. The method of claim 8, wherein the selected experiential activity comprises a plurality of levels of difficulty.

14. The method of claim 8, wherein each experiential activity has an associated goal, the associated goal selected from the group comprising self-reflection, getting to know people, trust building, team building, communication, conflict resolution, ice breaking, group bonding, problem solving, teamwork, group dynamics, common goal, get participants outside of their comfort zones, consensus building, energizer, and goal setting.

15. A system for remote experiential teambuilding activities, the system comprising:
a local computing device;
at least one remote computing device; and
a network,
the local computing device comprising a communication circuitry configured to couple to the at least one remote computing device via the network, each remote computing device associated with a respective remote participant, and a user interface (UI) configured to receive a local user input from a local participant, and to provide at least one of a local device output or a remote device output to the local participant, the local user input, local device output and remote device output related to a selected experiential activity.

16. The system of claim 15, wherein the selected experiential activity is selected from the group comprising Team Tapestry, Human Mirror, Me-Moji, Ship Shape, Fact or Fiction, Robot Assembly, Virtual Card Pick-Up, Link to Link, Survey Says, Take a Stand, Straw Stacker, Stranded in Quarantine and Codebreaker.

17. The system of claim 15, wherein the local computing device further comprises storage configured to store a plurality of modules, each module corresponding to a selected off-the-shelf application or program.

18. The system of claim 15, wherein the UI comprises one or more of a camera, a microphone, and/or a loudspeaker, and is configured to facilitate engagement of the local participant in the experiential activity in a virtual environment.

19. The system of claim 17, wherein each module is selected from the group comprising a web browser, a search engine, a virtual platform configured to facilitate remote video communication, a game-based learning platform, an online encyclopedia, a chat application, a messaging application, a drawing application, a live polling platform, a website that provides digital images “emojis” used to express emotion, an application with forms, and/or a presentation application.

20. The system of claim 15, wherein the selected experiential activity comprises a plurality of levels of difficulty.
